(19) United States
(12) Patent Application Publication
(10) Pub. No.: US 2021/0296737 A1
(43) Pub. Date: Sep. 23, 2021

(54) IMPROVED LEAD ACID BATTERY SEPARATORS, WATER LOSS REDUCING SEPARATORS, ANTIMONY POISONING MITIGATING SEPARATORS, BATTERIES, SYSTEMS, AND RELATED METHODS

(71) Applicant: Daramic, LLC, Charlotte, NC (US)

(72) Inventors: James P. Perry, Utica, KY (US); Neal M. Golovin, Owensboro, KY (US); Daniel R. Alexander, Matthews, NC (US); Eric Killmeier, Owensboro, KY (US); J. Kevin Whear, Utica, KY (US)

(21) Appl. No.: 17/262,102

(22) PCT Filed: Jul. 22, 2019
(86) PCT No.: PCT/US2019/042760

§ 371 Date: Jan. 21, 2021

Related U.S. Application Data
(60) Provisional application No. 62/702,018, filed on Jul. 23, 2018.

(51) Int. Cl. H01M 50/491; H01M 50/429; H01M 50/44; H01M 50/446; H01M 50/437; B60L 50/64; H01M 50/403; H01M 50/417; H01M 50/42

(52) U.S. Cl. CPC H01M 50/491; H01M 50/4295; H01M 50/44; H01M 50/446; H01M 10/12; B60L 50/64; H01M 50/403; H01M 50/417; H01M 50/42; H01M 50/437

(57) ABSTRACT

Disclosed herein are exemplary embodiments of improved separators for batteries, particularly lead acid batteries, and more particularly enhanced flooded lead acid batteries, improved lead acid batteries incorporating the improved separators, systems incorporating the improved separators and/or batteries, and methods related thereto. The improved separators may contain a cross-linkable component and a surfactant, agent, or additive. Furthermore, the cross-linkable component may be at least partially cross-linked. In addition, the separator may further be composed of a polymer and a filler, and may be additionally paired with a fibrous mat.

### RELATED APPLICATIONS

This application is a 371 Application which claims priority to PCT/US2019/042760, filed Jul. 22, 2019, which claims priority to and benefit of U.S. Provisional App. No. 62/702,018, filed on Jul. 23, 2018.

### FIELD

In accordance with at least select embodiments, the present disclosure or invention is directed to novel or improved membranes or separators for lead acid batteries, such as flooded lead acid batteries, and in particular enhanced flooded lead acid batteries (“EFBs”), and various other lead acid batteries, such as gel and absorptive glass mat (“AGM”) batteries, deep cycle batteries, golf car batteries, and/or the like. In accordance with at least select embodiments, the present disclosure or invention is directed to novel or improved separators, battery separators, low water loss separators, oxidation resistant separators, NCR separators, grid warp resistant separators, resilient separators, acid mixing separators, balanced separators, EFB separators, separators that improve battery performance, separators that dramatically improve battery performance, batteries, improved batteries, dramatically improved batteries, cells, systems, methods involving the same, vehicles using the same, methods of manufacturing the same, the use of the same, and/or combinations thereof. In addition, disclosed herein are methods, systems, and battery separators for enhancing battery life and reducing battery failure by reducing battery electrode shorting, reducing water loss, reducing electrical resistance, improving cycle life, and/or the like.

In accordance with at least select embodiments, the present disclosure or invention is directed to novel or improved separators, battery cells, batteries, systems, vehicles, and/or methods of manufacture and/or use of such novel separators, battery cells, and/or batteries. In accordance with at least certain embodiments, the present disclosure or invention is directed to novel or improved battery separators for the following batteries and/or applications, such as: flat-plate batteries, tubular batteries, flooded lead acid batteries, enhanced flooded lead acid batteries (“EFBs”), deep-cycle batteries, gel batteries, absorptive glass mat (“AGM”) batteries, valve regulated lead acid (“VRLA”) batteries, deep cycling batteries and/or batteries operating in a partial state of charge (“PSoC”), uninterruptible power supply (“UPS”) batteries, inverter batteries, renewable energy storage batteries, solar or wind power storage batteries, vehicle batteries, starting-lighting-ignition (“SLI”) vehicle batteries, idling-start-stop (“ISS”) vehicle batteries, hybrid-electric vehicle (“HEV”) batteries, hybrid vehicles, electric vehicles, batteries with high cold-cranking amp (“CCA”) requirements, batteries for internal combustion engines, marine battery applications, automobile batteries, truck batteries, motorcycle batteries, all-terrain vehicle batteries, forklift batteries, golf cart batteries, hybrid-electric vehicle batteries, electric vehicle batteries, e-rickshaw batteries, e-bike batteries, and/or the like, and/or improved methods of making and/or using such improved separators, cells, batteries, systems, and/or the like. In addition, disclosed herein are methods, systems and battery separators for enhancing battery performance and life, reducing battery failure, reducing water loss, mitigating antimony (Sb) poisoning, reducing acid stratification, mitigating dendrite formation, improving oxidation stability, improving, maintaining, and/or lowering float current, improving end of charge current, decreasing the current and/or voltage needed to charge and/or fully charge a deep cycle battery, reducing internal electrical resistance, improving energy throughput, improving acid diffusion, improving uniformity in a lead acid battery, and/or improving cycle life or cycle performance. In accordance with at least particular embodiments, the present disclosure or invention is directed to an improved separator wherein the novel separator includes improved wettability, decreased water loss in a battery, decreased antimony (Sb) poisoning in a battery, decreased electrical resistance, performance-enhancing additives or coatings, improved fillers, optimized porosity, increased wettability, increased acid diffusion, negative cross ribs, and/or the like.

In accordance with at least selected embodiments, the present disclosure or invention is directed to separators, particularly separators for flooded lead acid batteries, capable of reducing or mitigating battery water loss, reducing antimony (Sb) poisoning, mitigating electrode plate grid warping or bowing or cupping; reducing or mitigating acid starvation; reducing or mitigating acid stratification; reducing or mitigating dendrite growth; reducing the effects of oxidation; reducing water loss; increasing wettability; improving acid diffusion; improving uniformity; and having reduced electrical resistance, capable of increasing cold cranking amps, and/or the like; and combinations thereof. In addition, disclosed herein are methods, systems, and battery separators for enhancing battery life; reducing battery water loss; reducing battery antimony (Sb) poisoning; reducing or mitigating electrode plate grid warping or bowing or cupping; reducing or mitigating acid starvation; reducing or mitigating acid stratification; reducing or mitigating dendrite growth; reducing the effects of oxidation; reducing internal resistance; increasing wettability; improving acid diffusion; improving cold cranking amps; improving uniformity; and/or the like; and any combination thereof in at least enhanced flooded lead acid batteries. In accordance with at least particular embodiments, the present disclosure or invention is directed to an improved separator for enhanced flooded lead acid batteries wherein the separator includes an improved formulation for reduced battery water loss and reduced antimony (Sb) poisoning, an improved separator grid-warp resistance, improved separator resiliency; and combinations thereof. In accordance with at least particular embodiments, the present disclosure or invention is directed to improved separators for enhanced flooded lead acid batteries wherein the separator includes an improved formulation including cross-linked components, performance-enhancing agents, additives, surfactants, or coatings, increased oxidation resistance, amorphous silica, higher oil absorption silica, higher silanol group silica, silica with an OH:Si ratio of 21:100 to 35:100, a polyolefin microporous membrane containing particle-like filler in an amount of 40% or more by weight of the membrane and polymer, such as ultrahigh molecular weight polyethylene (“UHMWPE”), decreased sheet thickness, reduced thickness, reduced oil content, increased wettability, increased acid diffusion, and/or the like, and any combination thereof.

### BACKGROUND

For at least certain applications or batteries, there remains a need for improved separators providing for reduced battery failure, improved battery cycle life, and/or improved performance in a partial state of charge, and/or the like. More particularly, there remains a need for improved separators, improved batteries, and improved systems, such as those having reduced water loss or reduced hydrogen (H₂) evolution in a lead acid battery, reduced antimony (Sb) poisoning in a battery, lower battery float current, improved battery operation at a partial state of charge, enhanced battery life, reduced battery failure, improved batteries utilizing improved separators, systems utilizing improved batteries utilizing improved separators, and/or the like.

### SUMMARY

The details of one or more embodiments are in the description set forth hereinafter. Other features, objects, and advantages will be apparent from the description, drawings and/or claims. In accordance with at least select embodiments, the present disclosure or invention may address the above issues or needs. In accordance with at least certain embodiments, aspects, or objects, the present disclosure or invention may provide an improved separator, and/or an improved battery utilizing improved separators, and/or an improved system utilizing improved batteries utilizing improved separators that overcome the aforementioned problems. For instance by providing batteries having reduced water loss; reduced antimony poisoning, reduced float current; improved separator wettability; reduced acid stratification; reduced internal resistance; increased separator wettability; optimized porosity; improved acid diffusion through the separator; improved cold cranking amps, improved uniformity; and/or having improved cycling performance; and any combination thereof.

In a first select embodiment of the present disclosure or invention, a battery separator may be provided with a porous membrane and a performance-enhancing surfactant, agent, or additive (e.g., a coating of a surfactant and/or a water loss surfactant). In certain select embodiments, one or both of the porous membrane or performance-enhancing additive may have a cross-linkable component, which may be at least partially cross-linked. An alternative embodiment of a separator of the present invention may be provided with a polyolefin, an additional cross-linkable component, and a surfactant, agent, or additive; the additional cross-linkable component may be at least partially cross-linked. In other embodiments, the separator may be provided with a fibrous mat that may or may not have a cross-linkable component that may be at least partially cross-linked.

In certain aspects, the cross-linkable component may be at least partially cross-linked via thermal cross-linking; radiative cross-linking; chemical cross-linking; physical cross-linking; pressure cross-linking; and/or oxidative cross-linking; and any combination thereof. In addition, the cross-linkable component may be at least partially cross-linked via exposure to electron beam radiation; gamma radiation; ultra-violet light; vulcanization; and/or hydrogen peroxide (H₂O₂); and any combination thereof. Further, the cross-linkable component may be at least partially cross-linked at least one of: a covalent bond; an ionic bond; and a combination thereof.

In another aspect of the present invention, exemplary cross-linkable component may be at least one of the following: a natural rubber; latex; a synthetic rubber; a polymer; a phenolic resin; polyacrylamide resin; polyvinyl chloride (PVC); and/or bisphenol formaldehyde; and any combination thereof. Further, the separator may also have as a constituent material: a polymer; a polyolefin; polyethylene; polypropylene; ultra-high molecular weight polyethylene (“UHMWPE”); a lignin; a wood pulp; a synthetic wood pulp (“SWP”); glass fibers; synthetic fibers; and/or cellulosic fibers; and any combination thereof.

Exemplary battery separators may further have a particle-like filler. Exemplary fillers may include: amorphous silica; higher oil absorption silica; higher silanol group silica; silica with an OH to Si ratio of 21:100 to 35:100; and a combination thereof.

Exemplary performance-enhancing additives may include a surfactant and/or a water loss (as measured in a lead acid battery) retardant. Exemplary additives may be incorporated within said porous membrane and/or a coating on at least a portion of one and/or both surfaces of the separator.

Exemplary surfactants may have a hydrophilic lipophilic balance (HLB) at least greater than or equal to approximately one (1), and/or at most less than equal to approximately three (3). Exemplary surfactants may be one of an ionic surfactant; a non-ionic surfactant; and a combination thereof. Exemplary surfactants may further contain one or more of: a ethoxylated alcohol; a propoxylated alcohol; block copolymers of ethylene oxide; block copolymers of propylene oxide; polymerizable units; epoxies; urethanes; and any combination thereof. Exemplary surfactants may a surface weight on the separator of at least approximately 2.0 g/m², and/or no greater than approximately 10.0 g/m².

Exemplary separators of the present invention may have a first plurality of ribs that may be disposed on a first side of the separator. Exemplary embodiments of the first plurality of ribs may be a uniform set, an alternating set, or a mix or combination of at least one of: solid ribs, discrete broken ribs, continuous ribs, discontinuous ribs, discontinuous peaks, discontinuous protrusions, angled ribs, diagonal ribs, linear ribs, ribs that are longitudinally extending substantially in a machine direction of said porous membrane, ribs that are laterally extending substantially in a cross-machine direction of said porous membrane, ribs that are transversely extending substantially in said cross-machine direction of the separator, transversely extending negative mini ribs, negative cross ribs (NCR), acid mixing ribs, discrete teeth, toothed ribs, serrations, serrated ribs, battlements, battlemented ribs, curved ribs, continuous sinusoidal ribs, discontinuous sinusoidal ribs, S-shaped ribs, continuous zig-zag-sawtooth-like ribs, broken discontinuous zig-zag-sawtooth-like ribs, grooves, channels, textured areas, embossments, dimples, columns, mini columns, porous, non-porous, cross ribs, mini ribs, cross-mini ribs, and combinations thereof.

At least a portion of the first plurality of ribs may be defined by a first angle that is neither parallel nor orthogonal relative to an edge of the separator. Further, at least a portion of the first plurality of ribs may be defined by a first angle defined as relative to a machine direction of the separator that may be between greater than zero degrees (0°) and less than 180 degrees (180°), and greater than 180 degrees (180°) and less than 360 degrees (360°).

In addition, exemplary separators may have a second plurality of ribs, which may be disposed on a second side of the separator. Further, the second plurality of ribs may be a uniform set, an alternating set, or a mix or combination of at least one of the following group consisting of: solid ribs, discrete broken ribs, continuous ribs, discontinuous ribs, discontinuous peaks, discontinuous protrusions, angled ribs, diagonal ribs, linear ribs, ribs that are longitudinally extending substantially in a machine direction of said porous membrane, ribs that are laterally extending substantially in a cross-machine direction of said porous membrane, ribs that are transversely extending substantially in said cross-machine direction of the separator, transversely extending negative mini ribs, negative cross ribs (NCR), acid mixing ribs, discrete teeth, toothed ribs, serrations, serrated ribs, battlements, battlemented ribs, curved ribs, continuous sinusoidal ribs, discontinuous sinusoidal ribs, S-shaped ribs, continuous zig-zag-sawtooth-like ribs, broken discontinuous zig-zag-sawtooth-like ribs, grooves, channels, textured areas, embossments, dimples, columns, mini columns, porous, non-porous, cross ribs, mini ribs, cross-mini ribs, and combinations thereof.

In select embodiments, at least a portion of the second plurality of ribs may be defined by a second angle that is neither parallel nor orthogonal relative to an edge of the separator. Further, at least a portion of the second plurality of ribs may be defined by a second angle defined as relative to a machine direction of the porous membrane that may be between greater than zero degrees (0°) and less than 180 degrees (180°), and greater than 180 degrees (180°) and less than 360 degrees (360°).

Another aspect of the present invention may provide the separator as an envelope separator, a sleeve separator, a hybrid envelope separator, a pocket separator, a wrap separator, a cut-piece separator, a leaf separator, and/or an s-wrap separator.

In yet another aspect, the separator may be coupled with a fibrous mat, which may be nonwoven; mesh; fleece; net; and any combination thereof, and may further be layers of those elements. Exemplary fibrous mats may include one or more of glass fibers; synthetic fibers; silica; a cross-linkable component at least partially cross-linked; a surfactant; a water loss retardant; latex; natural rubber; synthetic rubber; a polymer; phenolic resin; polyacrylamide; polyvinyl chloride (PVC); bisphenol formaldehyde; and any combination thereof.

In select embodiments, a battery separator may be provided with a porous membrane, a fibrous mat, a cross-linkable component at least partially cross-linked, and a surfactant. Exemplary cross-linkable components may be at least partially provided within the fibrous mat. Further, exemplary surfactants may be at least partially provided within the fibrous mat. In addition, exemplary cross-linkable components and/or exemplary surfactants may be at least partially provided in or on the porous membrane.

In certain select embodiments, a lead acid battery is provided with at least one positive electrode, at least one negative electrode, a sulfuric acid (H₂SO₄) electrolyte; and an inventive battery separator as described herein. The positive electrode(s) may be provided with antimony (Sb) or as an antimony alloy. The exemplary separator may suppress antimony poisoning in the battery. In addition, the exemplary separator may suppress hydrogen (H₂) evolution and/or suppress electrolytic water loss in the battery.

Exemplary lead acid batteries may be one of: a flat-plate battery; a flooded lead acid battery; an enhanced flooded lead acid battery (“EFB”); a valve regulated lead acid (“VRLA”) battery; a deep-cycle battery; a gel battery; an absorptive glass mat (“AGM”) battery; a tubular battery; an inverter battery; a battery for an internal combustion engine; a vehicle battery; an auxiliary battery; a starting-lighting-ignition (“SLI”) vehicle battery; an idling-start-stop (“ISS”) vehicle battery; an automobile battery; a truck battery; a motorcycle battery; an all-terrain vehicle battery; a marine battery; an aircraft battery, a forklift battery; a golf cart battery; a hybrid-electric vehicle battery; an electric vehicle battery; an e-rickshaw battery; an e-trike battery; an e-bike battery; an uninterruptible power supply battery; a battery with high cold-cranking amps (“CCA”); and a combination thereof.

Exemplary lead acid batteries may operate in a partial state of charge (“PSoC”).

In certain select embodiments, a system having an inventive lead acid battery as described herein may be provided. The exemplary system may be one of: a vehicle; an uninterruptible power supply; an auxiliary power system; a renewable energy power collector; a wind energy power collector; a solar energy power collector; a backup power system; an inverter; and a combination thereof. Further, exemplary vehicles may be one of: an automobile; a passenger vehicle; a truck; a forklift; a hybrid vehicle; a hybrid-electric vehicle; a micro-hybrid vehicle; an idling-start-stop (“ISS”) vehicle; an electric vehicle; an e-bike, an e-rickshaw; an e-trike; a motorcycle; a water vessel; an aircraft, an all-terrain vehicle; a golf car; and a combination thereof.

Novel or improved separators, particularly separators for lead acid batteries; novel or improved separators, battery separators, batteries, cells, systems, vehicles, and/or methods of manufacture and/or use of such separators, battery separators, cells, systems, and/or batteries; an improved separator for lead acid batteries and/or improved methods of using such batteries having such improved separators; methods, systems, treatments, and battery separators for enhancing battery life, reducing battery failure, reducing battery water loss, reducing battery antimony poisoning, lowering battery float current, minimizing battery internal resistance increases, increasing separator wettability, reducing battery acid stratification, improving battery acid diffusion, and/or improving uniformity in lead acid batteries; an improved separator for lead acid batteries wherein the separator includes improved functional coatings, improved formulations, improved battery separators which reduce water loss in lead acid batteries, improved battery separators which reduce antimony poisoning in lead acid batteries, improved lead acid batteries including such improved separators, long life lead acid batteries, improved flooded lead acid batteries, improved enhanced flooded lead acid batteries, improved deep cycle batteries and/or batteries operating in a partial state of charge, and/or the like, and/or batteries having reduced antimony poisoning, reduced floating charges and/or reduced electrolysis and/or reduced rates of water loss; a polymer separator comprising a cross-linkable component and a surfactant; a separator comprising a cross-linkable component and an surfactant; a polymer separator comprising a cross-linkable component and a surfactant additive; a separator comprising a cross-linkable component and a surfactant additive; a polymer separator comprising a cross-linkable component and a surfactant coating; a separator comprising a cross-linkable component and a surfactant coating; a polymer separator comprising a cross-linkable component and a battery water loss reducing additive; a separator comprising a cross-linkable component and a battery water loss reducing additive; a polymer separator comprising a cross-linkable component at least partially cross-linked, and a surfactant; a separator comprising a cross-linkable component at least partially cross-linked and an surfactant; a polymer separator comprising a cross-linkable component at least partially cross-linked and a surfactant additive; a separator comprising a cross-linkable component at least partially cross-linked and a surfactant additive; a polymer separator comprising a cross-linkable component at least partially cross-linked and a surfactant coating; a separator comprising a cross-linkable component at least partially cross-linked and a surfactant coating; a polymer separator comprising a cross-linkable component at least partially cross-linked and a battery water loss reducing additive; a separator comprising a cross-linkable component at least partially cross-linked and a battery water loss reducing additive, and/or the like as shown or described herein; a battery separator and/or the like as shown or described herein.

In certain preferred embodiments the present disclosure or invention provides a battery separator, whose components and physical attributes and features synergistically combine to address, in unexpected ways, previously unmet needs in the lead acid battery industry and further expands the state of the art. In certain preferred embodiments, the present disclosure or invention provides an improved battery separator, which may be provided with a cross-linkable component and a certain amount of a performance-enhancing additive, such as a surfactant or water loss retardant, that meets or, in certain embodiments, exceeds the performance of previously known battery separators. In particular, the inventive separators described herein reduce the effects of antimony (Sb) poisoning in lead acid batteries, reduce water loss or hydrogen (H₂) evolution in lead acid batteries, reduce acid stratification in lead acid batteries, such as flooded lead acid batteries, and further provide many other advantages.

In accordance with at least selected embodiments, objects or aspects of the present invention, provided or disclosed herein are exemplary embodiments of novel or improved membranes, microporous membranes, separators for batteries, particularly lead acid batteries, and more particularly enhanced flooded lead acid batteries, improved lead acid batteries incorporating the improved separators, systems incorporating the improved separators and/or batteries, and/or methods related thereto that may address the problems, issues, or shortcomings of prior membranes, separators, batteries, systems, and/or the like. The novel or improved separators may contain a cross-linkable component and a surfactant, agent, or additive. Furthermore, the cross-linkable component may be at least partially cross-linked. In addition, the separator may further be composed of a polymer and a filler, and may be additionally paired with at least one fibrous mat or scrim, may be a piece, sleeve, pocket, envelope, wrap, fold, or the like, and/or combinations thereof.

In accordance with at least selected embodiments, the present disclosure or invention may address the above issues or needs. In accordance with at least certain objects, the present disclosure or invention may provide an improved separator and/or battery which overcomes the aforementioned problems, for instance by providing enhanced flooded batteries having reduced antimony suppression, reduced hydrogen evolution and reduced water loss, and reduced acid starvation.

### BRIEF DESCRIPTION OF THE FIGURES

FIG. 1 is a cutaway schematic illustration of a typical lead acid battery.

FIG. 2 depicts rib patterns on opposing sides of an exemplary separator. Ribs are depicted ribs longitudinally disposed on the separator, in a machine direction (“MD”), and laterally disposed on the separator, in a cross-machine direction (“CMD”).

FIGS. 3A and 3B are cyclic voltammetry results for a separator having cross-linked polyphenolic resin.

FIGS. 4A and 4B are cyclic voltammetry results for a separator having cross-linked rubber.

### DETAILED DESCRIPTION

In accordance with at least select embodiments, the present disclosure or invention may address the above issues or needs. In accordance with at least certain objects, aspects, or embodiments, the present disclosure or invention may provide an improved separator and/or battery which overcomes the aforementioned problems, for instance by providing batteries with separators with increased wettability, reduced water loss, and reduced antimony (Sb) poisoning.

In accordance with at least select embodiments, the present disclosure or invention is directed to novel or improved separators, battery cells, batteries, systems, vehicles, and/or methods of manufacture and/or use of such novel separators, battery cells, and/or batteries. In accordance with at least certain embodiments, the present disclosure or invention is directed to novel or improved battery separators for the following batteries and/or applications, such as: flat-plate batteries, tubular batteries, flooded lead acid batteries, enhanced flooded lead acid batteries (“EFBs”), deep-cycle batteries, gel batteries, absorptive glass mat (“AGM”) batteries, valve regulated lead acid (“VRLA”) batteries, deep cycling batteries and/or batteries operating in a partial state of charge (“PSoC”), uninterruptible power supply (“UPS”) batteries, inverter batteries, renewable energy storage batteries, solar or wind power storage batteries, vehicle batteries, starting-lighting-ignition (“SLI”) vehicle batteries, idling-start-stop (“ISS”) vehicle batteries, hybrid-electric vehicle (“HEV”) batteries, hybrid vehicles, electric vehicles, batteries with high cold-cranking amp (“CCA”) requirements, batteries for internal combustion engines, marine battery applications, batteries for aircraft, automobile batteries, truck batteries, motorcycle batteries, all-terrain vehicle batteries, forklift batteries, golf cart batteries, hybrid-electric vehicle batteries, electric vehicle batteries, e-rickshaw batteries, e-bike batteries, and/or the like, and/or improved methods of making and/or using such improved separators, cells, batteries, systems, and/or the like. In addition, disclosed herein are methods, systems and battery separators for enhancing battery performance and life, reducing battery failure, reducing water loss, mitigating antimony (Sb) poisoning, reducing acid stratification, mitigating dendrite formation, improving oxidation stability, improving, maintaining, and/or lowering float current, improving end of charge current, decreasing the current and/or voltage needed to charge and/or fully charge a deep cycle battery, reducing internal electrical resistance, improving acid diffusion, improving uniformity in a lead acid battery, and/or improving cycle performance. In accordance with at least particular embodiments, the present disclosure or invention is directed to an improved separator wherein the novel separator includes improved wettability, decreased water loss in a battery, decreased antimony (Sb) poisoning in a battery, decreased electrical resistance, performance-enhancing additives or coatings, improved fillers, optimized porosity, increased wettability, increased acid diffusion, negative cross ribs, and/or the like.

In accordance with at least selected embodiments, the present disclosure or invention is directed to separators, particularly separators for flooded lead acid batteries, capable of reducing or mitigating battery water loss or reducing hydrogen evolution in a battery, reducing antimony (Sb) poisoning, reducing or mitigating acid starvation; reducing or mitigating acid stratification; reducing or mitigating dendrite growth; reducing the effects of oxidation; increasing wettability; improving acid diffusion; improving uniformity; and having reduced electrical resistance, capable of increasing cold cranking amps, and/or the like; and combinations thereof. In addition, disclosed herein are methods, systems, and battery separators for enhancing battery life; reducing battery water loss or reducing hydrogen evolution in a battery; reducing battery antimony (Sb) poisoning; reducing or mitigating acid starvation; reducing or mitigating acid stratification; increasing wettability; improving acid diffusion; improving cold cranking amps; improving uniformity; and/or the like; and any combination thereof in at least enhanced flooded lead acid batteries. In accordance with at least particular embodiments, the present disclosure or invention is directed to an improved separator for enhanced flooded lead acid batteries wherein the separator includes an improved formulation for reduced battery water loss and reduced antimony (Sb) poisoning, and combinations thereof. In accordance with at least particular embodiments, the present disclosure or invention is directed to improved separators for enhanced flooded lead acid batteries wherein the separator includes an improved formulation including cross-linkable components, performance-enhancing additives or coatings, amorphous silica, higher oil absorption silica, higher silanol group silica, silica with an OH:Si ratio of 21:100 to 35:100, a polyolefin microporous membrane containing particle-like filler in an amount of 40% or more by weight of the membrane and polymer, such as ultrahigh molecular weight polyethylene (“UHMWPE”), decreased sheet thickness, reduced thickness, reduced oil content, increased wettability, increased acid diffusion, and/or the like, and any combination thereof.

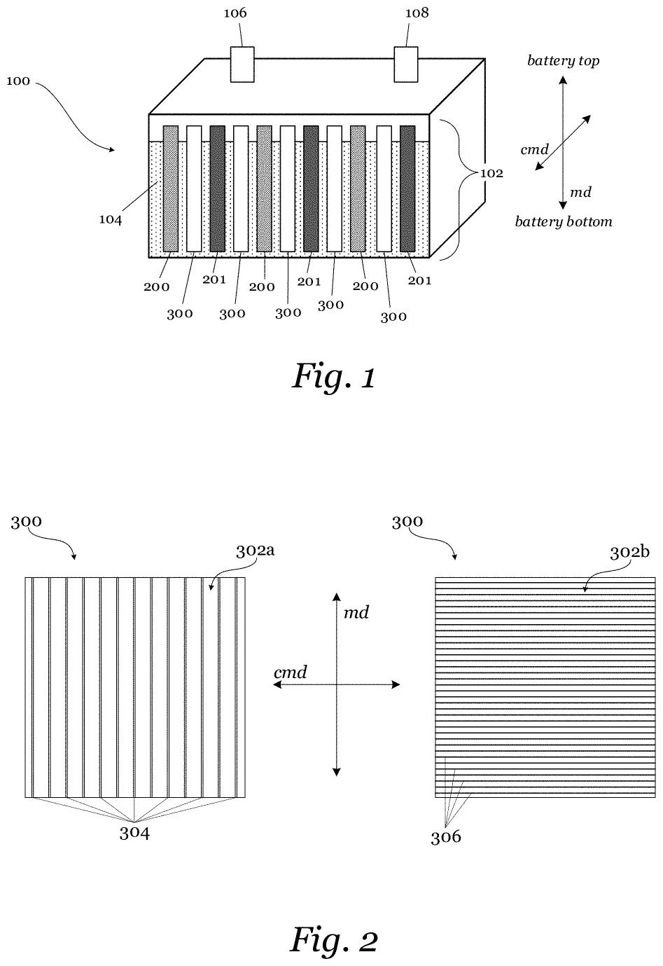

Referring to FIG. 1, an exemplary lead acid battery 100 has an array 102 of alternating positive electrode plates 200 (or positive electrodes) and negative electrode plates 201 (or negative electrodes) with separators 300 interleaved between each electrode 200, 201. The array 102 is substantially submerged in an electrolyte 104. The electrolyte 104 may be, for example, a solution of sulfuric acid (H₂SO₄) and water (H₂O). The electrolyte solution may have, for example, a specific gravity of approximately 1.28, with a range of approximately 1.215 to 1.300.

The battery 100 is further provided with a positive terminal 104 in electrical communication with the positive electrodes 200 and a negative terminal 106 in electrical communication with the negative electrodes 201. The electrodes 200, 201 may be doped with active material 203, FIGS. 2A and 2B. The positive electrodes 200 typically may be lead dioxide (PbO₂) or an alloy thereof. The negative electrodes 201 typically may be lead (Pb) or an alloy thereof. A common negative electrode alloy may include antimony (Sb).

### Composition

In certain embodiments, exemplary improved separators may include a porous membrane made of: a natural or synthetic base material, which may or may not be a material that is cross-linkable and/or a material that may be at least partially cross-linked; a processing plasticizer; a filler; and one or more other additives and/or coatings, and/or the like, such as a surfactant and/or a water loss retardant; and various combinations thereof. The amounts of the above constituent parts may be mixed in ratios to balance multiple factors such as separator properties and manufacturing efficiency. Such multiple factors may exemplary include suppression of battery water loss or hydrogen evolution, suppression of battery antimony poisoning, electrical resistance, basis weight, puncture resistance, bending stiffness, oxidation resistance, porosity, physical strength, and the like, and may further include manufacturing runnability for both separator and battery manufacturing.

The separator may further be paired with a fibrous mat in addition to the porous membrane. In addition, the fibrous mat may contain a material that is cross-linkable and/or a material that may be at least partially cross-linked; a processing plasticizer; a filler; and one or more other additives and/or coatings, and/or the like, such as a surfactant and/or a water loss retardant; and various combinations thereof. In select embodiments, the separator and fibrous mat may be used alone or in combination with one another.

In certain embodiments, exemplary natural or synthetic materials may include thermoplastic polymers. Exemplary thermoplastic polymers may, in principle, include all acid-resistant thermoplastic materials suitable for use in lead acid batteries. In select embodiments, the porous membrane may include polymers; cross-linkable components; thermoplastic polymers; and polyolefins; and/or the like. In certain preferred embodiments, the polyolefins may include, for example, polyethylene, polypropylene, ethylene-butene copolymer, and any combination thereof, but preferably polyethylene. Preferably, the polyethylene is high molecular weight polyethylene (“HMWPE”), (e.g., polyethylene having a molecular weight of at least 600,000). Even more preferably, the polyethylene is ultra-high molecular weight polyethylene (“UHMWPE”). Exemplary UHMWPE may have a molecular weight of at least 1,000,000, in particular more than 4,000,000, and most preferably 5,000,000 to 8,000,000 as measured by viscosimetry and calculated by Margolie's equation. Further, exemplary UHMWPE may possess a standard load melt index of substantially zero (0) as measured as specified in ASTM D 1238 (Condition E) using a standard load of 2,160 g. Moreover, exemplary UHMWPE may have a viscosity number of not less than 600 ml/g, preferably not less than 1,000 ml/g, more preferably not less than 2,000 ml/g, and most preferably not less than 3,000 ml/g, as determined in a solution of 0.02 g of polyolefin in 100 g of decalin at 130° C.

In certain exemplary embodiments, the porous membrane may also contain lignins; wood pulp; synthetic wood pulp; glass fibers; synthetic fibers; cellulosic fibers; and combinations thereof. In certain preferable embodiments, an exemplary separator may be a porous membrane made from thermoplastic polymers.

### Cross-Linkable Components

In certain preferred embodiments, exemplary porous membranes contain cross-linkable components that may or may not be at least partially cross-linked. Exemplary cross-linkable components may include: a natural rubber; latex; a synthetic rubber; a polymer; a phenolic resin; polyacrylamide resin; polyvinyls such as polyvinyl chloride (PVC); bisphenol formaldehyde; and combinations thereof.

The novel separator disclosed herein may contain a rubber. As used herein, rubber shall describe, at least, rubber; latex; natural rubber; synthetic rubber; cross-linked or cross-linkable rubbers; cured or uncured rubber; crumb or ground rubber; shredded or recycled tire material; or mixtures thereof. Exemplary natural rubbers may include one or more blends of polyisoprenes; which are commercially available from a variety of suppliers. Exemplary synthetic rubbers include methyl rubber; polybutadiene; chloropene rubbers; butyl rubber; bromobutyl rubber; polyurethane rubber; epichlorhydrin rubber; polysulphide rubber; chlorosulphonyl polyethylene; polynorbornene rubber; acrylate rubber; fluorine rubber; silicone rubber; copolymer rubbers, such as styrene/butadiene rubbers, acrylonitrile/butadiene rubbers, ethylene/propylene rubbers (“EPM and EPDM”), ethylene/vinyl acetate rubbers, and combinations thereof. The rubber may be a cross-linked rubber or an uncross-linked cross-linkable rubber; in certain preferred embodiments, the rubber is uncross-linked cross-linkable rubber. In certain embodiments, the rubber may be a blend of cross-linked and uncross-linked cross-linkable rubber.

In select embodiments, the cross-linkable component may be at least partially cross-linked via at least one of the following methods, including: thermal cross-linking; radiative cross-linking; chemical cross-linking; physical cross-linking; pressure cross-linking; oxidative cross-linking; and combinations thereof. In addition, exemplary cross-linkable components may be at least partially cross-linked via exposure to at least one of the processes: electron beam radiation; gamma radiation; ultra-violet light; vulcanization; hydrogen peroxide (H₂O₂); and combinations thereof. Furthermore, exemplary cross-linkable components may be at least partially cross-linked via a covalent bond, an ionic bond, and a combination thereof.

In some embodiments, exemplary separators may or may not contain polyvinylidene fluoride (PVDF), polyvinyl fluoride (PVF), poly-3-hydroxybutyrate (PHB), poly(vinyl acetate) (PVAc), polychlorotrifluoroethylene (PCTFE), polyamide (PA), polylactic acid (PLA), polyethylene terephthalate (PET), poly(vinyl alcohol) (PVA), polystyrene (PS), poly(methyl methacrylate) (PMMA actactic), acrylonitrile butadiene styrene (ABS), polytetrafluoroethylene (PTFE), poly(carbonate) (PC), polysulfone, and various combinations thereof.

### Plasticizer

In certain embodiments, exemplary processing plasticizers may include processing oil, petroleum oil, paraffin-based mineral oil, mineral oil, and any combination thereof. The processing plasticizer may facilitate manufacturing processing, such as extruding and forming into the separator's physical form, and may then be removed and/or extracted prior to finishing the final product.

### Fillers

The separator can contain a filler having a high structural morphology. Exemplary fillers can include: silica, dry finely divided silica; precipitated silica; amorphous silica; highly friable silica; alumina; talc; fish meal; fish bone meal; carbon; carbon black; and the like, and combinations thereof. In certain preferred embodiments, the filler is one or more silicas. High structural morphology refers to increased surface area. The filler can have a high surface area, for instance, greater than 100 m²/g, 110 m²/g, 120 m²/g, 130 m²/g, 140 m²/g, 150 m²/g, 160 m²/g, 170 m²/g, 180 m²/g, 190 m²/g, 200 m²/g, 210 m²/g, 220 m²/g, 230 m²/g, 240 m²/g, or 250 m²/g. In some embodiments, the filler (e.g., silica) can have a surface area from 100-300 m²/g, 125-275 m²/g, 150-250 m²/g, or preferably 170-220 m²/g. Surface area can be assessed using TriStar 3000™ for multipoint BET nitrogen surface area. High structural morphology permits the filler to hold more oil during the manufacturing process. For instance, a filler with high structural morphology has a high level of oil absorption, for instance, greater than about 150 ml/100 g, 175 ml/100 g, 200 ml/100 g, 225 ml/100 g, 250 ml/100 g, 275 ml/100 g, 300 ml/100 g, 325 ml/100 g, or 350 ml/100 g. In some embodiments the filler (e.g., silica) can have an oil absorption from 200-500 ml/100 g, 200-400 ml/100 g, 225-375 ml/100 g, 225-350 ml/100 g, 225-325 ml/100 g, preferably 250-300 ml/100 g. In some instances, a silica filler is used having an oil absorption of 266 ml/100 g. Such a silica filler has a moisture content of 5.1%, a BET surface area of 178 m2/g, an average particle size of 23 μm, a sieve residue 230 mesh value of 0.1%, and a bulk density of 135 g/L.

Silica with relatively high levels of oil absorption and relatively high levels of affinity for the plasticizer (e.g., mineral oil) becomes desirably dispersible in the mixture of polyolefin (e.g., polyethylene) and the plasticizer when forming an exemplary lead acid battery separator of the type shown herein. In the past, some separators have experienced the detriment of poor dispersibility caused by silica aggregation when large amounts of silica are used to make such separators or membranes. In at least certain of the inventive separators shown and described herein, the polyolefin, such as polyethylene, forms a shish-kebab structure, since there are few silica aggregations or agglomerates that inhibit the molecular motion of the polyolefin at the time of cooling the molten polyolefin. All of this contributes to improved ion permeability through the resulting separator membrane, and the formation of the shish-kebab structure or morphology means that mechanical strength is maintained or even improved while a lower overall ER separator is produced.

In some select embodiments, the filler (e.g., silica) may be friable and/or may have an average particle size no greater than 25 μm, in some instances, no greater than 22 μm, 20 μm, 18 μm, 15 μm, or 10 μm. In some instances, the average particle size of the filler particles is 15-25 μm. The particle size of the silica filler and/or the surface area of the silica filler contributes to the oil absorption of the silica filler. Silica particles in the final product or separator may fall within the sizes described above. However, the initial silica used as raw material may come as one or more agglomerates and/or aggregates and may have sizes around 200 μm or more.

In some preferred embodiments, the silica used to make the inventive separators has an increased amount of or number of surface silanol groups (surface hydroxyl groups) compared with silica fillers used previously to make lead acid battery separators. For example, the silica fillers that may be used with certain preferred embodiments herein may be those silica fillers having at least 10%, at least 15%, at least 20%, at least 25%, at least 30%, or at least 35% more silanol and/or hydroxyl surface groups compared with known silica fillers used to make known polyolefin lead acid battery separators.

The ratio (Si—OH)/Si of silanol groups (Si—OH) to elemental silicon (Si) can be measured, for example, as follows.

1. Freeze-crush a polyolefin porous membrane (where certain inventive membranes contain a certain variety of oil-absorbing silica according to the present invention), and prepare the powder-like sample for the solid-state nuclear magnetic resonance spectroscopy (²⁹Si-NMR).

2. Perform the ²⁹Si-NMR to the powder-like sample, and observe the spectrums including the Si spectrum strength which is directly bonding to a hydroxyl group (Spectrum: Q₂ and Q₃) and the Si spectrum strength which is only directly bonding to an oxygen atom (Spectrum: Q₄), wherein the molecular structure of each NMR peak spectrum can be delineated as follows:
Q₂: (SiO)₂—Si*—(OH)₂: having two hydroxyl groups
Q₃: (SiO)₃—Si*—(OH): having one hydroxyl group
Q₄: (SiO)₄—Si*: All Si bondings are SiO
   Where Si* is proved element by NMR observation.

3. The conditions for ²⁹Si-NMR used for observation are as follows:
Instrument: Bruker BioSpin Avance 500
Resonance Frequency: 99.36 MHz
Sample amount: 250 mg
NMR Tube: 7 mφ
Observing Method: DD/MAS
Pulse Width: 45°
Repetition time: 100 sec
Scans: 800
Magic Angle Spinning: 5,000 Hz
Chemical Shift Reference: Silicone Rubber as −22.43 ppm

4. Numerically, separate peaks of the spectrum, and calculate the area ratio of each peak belonging to Q₂, Q₃, and Q₄. After that, based on the ratios, calculate the molar ratio of hydroxyl groups (—OH) bonding directly to Si. The conditions for the numerical peak separation is conducted in the following manner:
Fitting region: −80 to −130 ppm
Initial peak top: −93 ppm for Q₂, −101 ppm for Q₃, −111 ppm for Q₄, respectively.
Initial full width half maximum: 400 Hz for Q₂, 350 Hz for Q₃, 450 Hz for Q₄, respectively.
Gaussian function ratio: 80% at initial and 70 to 100% while fitting.

5. The peak area ratios (Total is 100) of Q₂, Q₃, and Q₄ are calculated based on the each peak obtained by fitting. The NMR peak area corresponded to the molecular number of each silicate bonding structure (thus, for the Q₄ NMR peak, four Si—O—Si bonds are present within that silicate structure; for the Q₃ NMR peak, three Si—O—Si bonds are present within that silicate structure while one Si—OH bond is present; and for the Q₂ NMR peak, two Si—O—Si bonds are present within that silicate structure while two Si—OH bonds are present). Therefore each number of the hydroxyl group (—OH) of Q₂, Q₃, and Q₄ is multiplied by two (2) one (1), and zero (0), respectively. These three results are summed. The summed value displays the mole ratio of hydroxyl groups (—OH) directly bonding to Si.

In certain embodiments, the silica may have a molecular ratio of OH to Si groups, measured by ²⁹Si-NMR, that may be within a range of approximately 21:100 to 35:100, in some preferred embodiments approximately 23:100 to approximately 31:100, in certain preferred embodiments, approximately 25:100 to approximately 29:100, and in other preferred embodiments at least approximately 27:100 or greater.

In some select embodiments, use of the fillers described above permits the use of a greater proportion of processing oil during the extrusion step. As the porous structure in the separator is formed, in part, by removal of the oil after the extrusion, higher initial absorbed amounts of oil results in optimized porosity or optimized void volume. While processing oil is an integral component of the extrusion step, oil is a non-conducting component of the separator. Residual oil in the separator protects the separator from oxidation when in contact with the positive electrode. The precise amount of oil in the processing step may be controlled in the manufacture of conventional separators. Generally speaking, conventional separators are manufactured using 50-70% processing oil, in some embodiments, 55-65%, in some embodiments, 60-65%, and in some embodiments, about 62% by weight processing oil. Reducing oil below about 59% is known to cause burning due to increased friction against the extruder components. However, increasing oil much above the prescribed amount may cause shrinking during the drying stage, leading to dimensional instability. Although previous attempts to increase oil content resulted in pore shrinkage or condensation during the oil removal, separators prepared as disclosed herein exhibit minimal, if any, shrinkage and condensation during oil removal. Thus, porosity can be optimized without compromising pore size and dimensional stability, thereby decreasing electrical resistance.

In certain select embodiments, the use of the filler described above allows for a reduced final oil concentration in the finished separator. Since oil is a non-conductor, reducing oil content can increase the ionic conductivity of the separator and assist in lowering the ER of the separator. As such, separators having reduced final oil contents can have increased efficiency. In certain select embodiments are provided separators having a final processing oil content (by weight) less than 20%, for example, between about 14% and 20%, and in some particular embodiments, less than 19%, 18%, 17%, 16%, 15%, 14%, 13%, 12%, 11%, 10%, 9%, 8%, 7%, 6%, or 5%.

The fillers may further reduce what is called the hydration sphere of the electrolyte ions, enhancing their transport across the membrane, thereby once again lowering the overall electrical resistance or ER of the battery, such as an enhanced flooded battery or system.

The filler or fillers may contain various species (e.g., polar species, such as metals) that facilitate the flow of electrolyte and ions across the separator. Such also leads to decreased overall electrical resistance as such a separator is used in a flooded battery, such as an enhanced flooded battery.

In certain select embodiments, the filler can be an alumina, talc, silica, or a combination thereof. In some embodiments, the filler can be a precipitated silica, and in some embodiments, the precipitated silica is amorphous silica. In some embodiments, it is preferred to use aggregates and/or agglomerates of silica which allow for a fine dispersion of filler throughout the separator, thereby decreasing tortuosity and electrical resistance. In certain preferred embodiments, the filler (e.g., silica) is characterized by a high level of friability. Good friability enhances the dispersion of the filler throughout the polymer during extrusion of the porous membrane, enhancing porosity and thus overall ionic conductivity through the separator. Friability may be measured as the ability, tendency or propensity of the silica particles or material (aggregates or agglomerates) to be broken down into smaller sized and more dispersible particles, pieces or components. The more friable silica may be broken down during existing manufacturing processes such as during extrusion or pre-extrusion mixing, or by addition processes such as sonication.

The use of a filler having one or more of the above characteristics enables the production of a separator having a higher final porosity. The separators disclosed herein may have a final porosity greater than 60%, 61%, 62%, 63%, 64%, 65%, 66%, 67%, 68%, 69%, or 70%. Porosity may be measured using gas adsorption methods. Porosity may be measured by BS-TE-2060.

In some select embodiments, the porous separator can have a greater proportion of larger pores while maintaining the average pore size no greater than about 1 μm, 0.9 μm, 0.8 μm, 0.7 μm, 0.6 μm, 0.5 μm, or 0.1 μm.

### Additives

In certain embodiments, exemplary separators may contain one or more performance-enhancing surfactants, agents, or additives added to the separator or porous membrane. The performance-enhancing additive may be one or more of surfactants, wetting agents, water loss (as exhibited in a battery) retardants, antimony suppressing additives, antioxidants, colorants, antistatic additives, UV-protection additives, and/or the like, and any combination thereof. In certain embodiments, the additive surfactants may be ionic, or non-ionic surfactants. In certain embodiments, the performance-enhancing additive may possess a cross-linkable component. In some embodiments, that cross-linkable component may be at least partially cross-linked. The components and cross-linking methods may be substantially the same as generally described hereinbefore.

In certain embodiments described herein, a reduced amount of ionic or non-ionic surfactant is added to the inventive porous membrane or separator. Because of the lower amount of surfactant, a desirable feature may include lowered total organic carbons (“TOCs”) and/or lowered volatile organic compounds (“VOCs”).

Certain suitable surfactants are non-ionic while other suitable surfactants are anionic. The additive may be a single surfactant or a mixture of two or more surfactants, for instance two or more anionic surfactants, two or more non-ionic surfactants, or at least one ionic surfactant and at least one non-ionic surfactant. Certain suitable surfactants may have HLB between approximately 1 and approximately 6, certain preferred values may be between approximately 1 and approximately 3. The use of these certain suitable surfactants in conjunction with the inventive separators described herein can lead to even further improved separators that, when used in a lead acid battery, lead to reduced water loss, reduced antimony poisoning, improved cycling, reduced float current, reduced float potential, and/or the like, or any combination thereof for that lead acid batteries. Suitable surfactants include surfactants such as salts of alkyl sulfates; alkylarylsulfonate salts; alkylphenol-alkylene oxide addition products; soaps; alkyl-naphthalene-sulfonate salts; one or more sulfo-succinates, such as an anionic sulfo-succinate; dialkyl esters of sulfo-succinate salts; amino compounds (primary, secondary, tertiary amines, or quaternary amines); block copolymers of ethylene oxide and propylene oxide; polymerizable units; epoxies; urethanes; various polyethylene oxides; and salts of mono and dialkyl phosphate esters. The additive can include a non-ionic surfactant such as polyol fatty acid esters, polyethoxylated esters, polyethoxylated alcohols, alkyl polysaccharides such as alkyl polyglycosides and blends thereof, amine ethoxylates, sorbitan fatty acid ester ethoxylates, organosilicone based surfactants, ethylene vinyl acetate terpolymers, ethoxylated alkyl aryl phosphate esters and sucrose esters of fatty acids.

In certain embodiments, the additive may be represented by a compound of Formula (I)

R(OR¹)ₙ(COOM_{1/x}^{x+})ₘ (I)

in which:
R is a linear or non-aromatic hydrocarbon radical with 10 to 4200 carbon atoms, preferably 13 to 4200, which may be interrupted by oxygen atoms;
R¹=H, —(CH₂)ₖCOOM^{x+}_{1/x} or —(CH₂)ₖ—SO₃M^{x+}_{1/x}, preferably H, where k=1 or 2;
M is an alkali metal or alkaline-earth metal ion, H⁺ or NH₄⁺, where not all the variables M simultaneously have the meaning H⁺;
n=0 or 1;
m=0 or an integer from 10 to 1400; and
x=1 or 2.

The ratio of oxygen atoms to carbon atoms in the compound according to Formula (I) being in the range from 1:1.5 to 1:30 and m and n not being able to simultaneously be 0. However, preferably only one of the variables n and m is different from 0.

By non-aromatic hydrocarbon radicals is meant radicals which contain no aromatic groups or which themselves represent one. The hydrocarbon radicals may be interrupted by oxygen atoms (i.e., contain one or more ether groups).

R is preferably a straight-chain or branched aliphatic hydrocarbon radical which may be interrupted by oxygen atoms. Saturated, uncross-linked hydrocarbon radicals are quite particularly preferred. However, as noted above, R may, in certain embodiments, be aromatic ring-containing.

Through the use of the compounds of Formula (I) for the production of battery separators, they may be effectively protected against oxidative destruction.

Battery separators are preferred which contain a compound according to Formula (I) in which:
R is a hydrocarbon radical with 10 to 180, preferably 12 to 75 and quite particularly preferably 14 to 40 carbon atoms, which may be interrupted by 1 to 60, preferably 1 to 20 and quite particularly preferably 1 to 8 oxygen atoms, particularly preferably a hydrocarbon radical of formula R²—[(OC₂H₄)p(OC₃H₆)_{q}]—, in which:
   R² is an alkyl radical with 10 to 30 carbon atoms, preferably 12 to 25, particularly preferably 14 to 20 carbon atoms, wherein R² can be linear or non-linear such as containing an aromatic ring;
   P is an integer from 0 to 30, preferably 0 to 10, particularly preferably 0 to 4; and
   q is an integer from 0 to 30, preferably 0 to 10, particularly preferably 0 to 4;
   compounds being particularly preferred in which the sum of p and q is 0 to 10, in particular 0 to 4;
n=1; and
m=0.
   Formula R²—[(OC₂H₄)ₚ(OC₃H₆)_{q}]— is to be understood as also including those compounds in which the sequence of the groups in square brackets differs from that shown. For example according to the invention compounds are suitable in which the radical in brackets is formed by alternating (OC₂H₄) and (OC₃H₆) groups.
   Additives in which R² is a straight-chain or branched alkyl radical with 10 to 20, preferably 14 to 18 carbon atoms have proved to be particularly advantageous. OC₂H₄ preferably stands for OCH₂CH₂, OC₃H₆ for OCH(CH₃)₂ and/or OCH₂CH₂CH₃.

As preferred additives there may be mentioned in particular alcohols (p=q=0; m=0) primary alcohols being particularly preferred, fatty alcohol ethoxylates (p=1 to 4, q=0), fatty alcohol propoxylates (p=0; q=1 to 4) and fatty alcohol alkoxylates (p=1 to 2; q=1 to 4) ethoxylates of primary alcohols being preferred. The fatty alcohol alkoxylates are for example accessible through reaction of the corresponding alcohols with ethylene oxide or propylene oxide.

Additives of the type m=0 which are not, or only difficulty, soluble in water and sulphuric acid have proved to be particularly advantageous.

Also preferred are additives which contain a compound according to Formula (I), in which:
R is an alkane radical with 20 to 4200, preferably 50 to 750 and quite particularly preferably 80 to 225 carbon atoms;
M is an alkali metal or alkaline-earth metal ion, H⁺ or NH₄⁺, in particular an alkali metal ion such as Li⁺, Na⁺ and K⁺ or H⁺, where not all the variables M simultaneously have the meaning H⁺;
n=0;
m is an integer from 10 to 1400; and
x=1 or 2.

In certain embodiments, suitable additives may include, in particular, polyacrylic acids, polymethacrylic acids and acrylic acid-methacrylic acid copolymers, whose acid groups are at least partly neutralized, such as by preferably 40%, and particularly preferably by 80%. The percentage refers to the number of acid groups. Quite particularly preferred are poly(meth)acrylic acids which are present entirely in the salt form. Suitable salts include Li, Na, K, Rb, Be, Mg, Ca, Sr, Zn, and ammonium (NR₄, wherein R is either hydrogen or a carbon functional group). Poly(meth)acrylic acids may include polyacrylic acids, polymethacrylic acids, and acrylic acid-methacrylic acid copolymers. Poly(meth)acrylic acids are preferred and in particular polyacrylic acids with an average molar mass M_{w} of 1,000 to 100,000 g/mol, particularly preferably 1,000 to 15,000 g/mol and quite particularly preferably 1,000 to 4,000 g/mol. The molecular weight of the poly(meth)acrylic acid polymers and copolymers is ascertained by measuring the viscosity of a 1% aqueous solution, neutralized with sodium hydroxide solution, of the polymer (Fikentscher's constant).

Also suitable are copolymers of (meth)acrylic acid, in particular copolymers which, besides (meth)acrylic acid contain ethylene, maleic acid, methyl acrylate, ethyl acrylate, butyl acrylate and/or ethylhexyl acrylate as comonomer. Copolymers are preferred which contain at least 40% by weight and preferably at least 80% by weight (meth)acrylic acid monomer; the percentages being based on the acid form of the monomers or polymers.

To neutralize the polyacrylic acid polymers and copolymers, alkali metal and alkaline-earth metal hydroxides such as potassium hydroxide and in particular sodium hydroxide are particularly suitable. In addition, a coating and/or additive to enhance the separator may include, for example, a metal alkoxide, wherein the metal may be, by way of example only (not intended to be limiting), Zn, Na, or Al, by way of example only, sodium ethoxide.

In some embodiments, the porous polyolefin porous membrane may include a coating on one or both sides of such layer. Such a coating may include a surfactant or other material. In some embodiments, the coating may include one or more materials described, for example, in U.S. Pat. No. 9,876,209, which is incorporated by reference herein. Such a coating may, for example, reduce the water loss or hydrogen evolution of the battery system, thereby extending battery life.

In certain embodiments, a separator may contain a performance-enhancing additive in the form of a nucleation additive and/or coating. The nucleation additive may preferably be stable in the battery electrolyte, and may further be dispersed within the electrolyte.

Exemplary forms of nucleation additives and/or coatings may be or contain carbon, such as carbon, conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (Bucky Balls), an aqueous carbon suspension, and combinations thereof. In addition to these many forms of carbon, the nucleation additive and/or coating may also include or contain barium sulfate (BaSO₄) either alone or in combination with carbon.

The nucleation coating may be applied to a finished separator by such means as a slurry coating, slot die coating, spray coating, curtain coating, ink jet printing, screen printing, or by vacuum deposition or chemical vapor deposition (“CVD”). In addition, the additive and/or coating may be provided as carbon paper, either woven or nonwoven, and disposed between and in intimate contact with the separator and electrode(s).

The nucleation additive and/or coating may be within the separator, or on one or both electrode facing surfaces of the separator. Typically, a coating or layer of the nucleation additive may only be on the negative electrode facing surface. However, it may be on the positive electrode facing surface, or on both surfaces.

In certain embodiments, the nucleation additive may be added to the extrusion mix of base materials and extruded with the separator, or co-extruded as a layer on the separator. When included in the extrusion mix, the nucleation additive may replace some of the silica filler by as much as 5% to 75% by weight. For example, the nucleation additive may be approximately 5%, 10%, 15%, 20%, 25%, 30%, 35%, 40%, 45%, 50%, 55%, 60%, 65%, 70%, or approximately 75% by weight. In other exemplary embodiments, the nucleation additive may be no greater than approximately 75%, 70%, 65%, 60%, 55%, 50%, 45%, 40%, 35%, 30%, 25%, 20%, 15%, 10%, or approximately 5% weight.

### Physical Description

An exemplary separator may be provided with a web of a porous membrane, such as a microporous membrane having pores less than about 5 μm, preferably less than about 1 μm, a mesoporous membrane, or a 27icroporous membrane having pores greater than about 1 μm. The porous membrane may preferably have a pore size that is sub-micron up to 100 μm, and in certain embodiments between about 0.1 μm to about 10 μm. Porosity of the separator membrane described herein may be greater than 50% to 60% in certain embodiments. In certain select embodiments, the porous membrane may be flat or possess ribs that extend from a surface thereof.

### Ribs

Referring to FIG. 2, an exemplary separator 300 is shown with opposing membrane surfaces 302a, 302b and arrays of ribs 304, 306 extending therefrom. In a typical lead acid battery, the exemplary separator 300 is disposed between electrodes such that the positive surface 302a is adjacent to and faces a positive electrode (see FIG. 1), and the negative surface 302b is adjacent to and faces a negative electrode (see FIG. 1). An array of positive ribs 304 extend from the positive surface 302a and an array of negative ribs 306 extend from the negative surface 302b. As shown, the positive ribs 304 are disposed longitudinally in a machine direction md of the separator 300, and the negative ribs 306 are disposed laterally in a cross-machine direction cmd of the separator 300 and as such may be called cross-negative ribs. As shown, the ribs 304, 306 are depicted as solid linear ribs, but preferred embodiments may possess ribs of a wide variety of configurations and/or profiles.

For instance, either array of ribs 304, 306 may be a uniform set, an alternating set, or a mix or combination of solid ribs, discrete broken ribs, continuous ribs, discontinuous ribs, discontinuous peaks, discontinuous protrusions, angled ribs, diagonal ribs, linear ribs, ribs that are longitudinally extending substantially in a machine direction md of the separator (i.e., running from top to bottom of the separator 300 in the battery 100 (see FIG. 1)), ribs that are laterally extending substantially in a cross-machine direction cmd of the separator (i.e., in a lateral direction of the separator 300 in the battery 100 (see FIG. 1), orthogonal to the machine direction md), ribs that are transversely extending substantially in said cross-machine direction of the separator, transversely extending negative mini ribs, negative cross ribs (NCR), acid mixing ribs, discrete teeth, toothed ribs, serrations, serrated ribs, battlements, battlemented ribs, curved ribs, continuous sinusoidal ribs, discontinuous sinusoidal ribs, S-shaped ribs, continuous zig-zag-sawtooth-like ribs, broken discontinuous zig-zag-sawtooth-like ribs, grooves, channels, textured areas, embossments, dimples, columns, mini columns, porous, non-porous, cross ribs, mini ribs, cross-mini ribs, and any combination thereof.

Furthermore, the ribs 304, 306 may be a plurality of ribs, preferably broken ribs, defined by an angle that is neither parallel nor orthogonal relative to an edge of separator. In other words, that angle may be defined as relative to a machine direction of the separator between greater than zero degrees (0°) and less than 180 degrees (180°)or greater than 180 degrees (180°) and less than 360 degrees (360°). In addition, that angle may be defined as relative to a cross-machine direction of the separator between greater than zero degrees (0°) and less than 180 degrees (180°) or greater than 180 degrees (180°) and less than 360 degrees (360°). The angled rib pattern may be a possibly preferred Daramic® RipTide™ acid mixing rib profile that can help reduce or eliminate acid stratification in certain batteries.

It should be noted that the positive ribs may alternatively be placed in an exemplary battery such that they contact the negative electrode. Likewise, the negative ribs may alternatively be placed in an exemplary battery such that they contact the positive electrode.

The ribs may extend uniformly across the width of the separator, from lateral edge to lateral edge. This is known as a universal profile. Alternatively, the separator may have side panels adjacent to the lateral edges with minor ribs disposed in the side panel. These minor ribs may be more closely spaced and smaller than the primary ribs. For instance, the minor ribs may be 25% to 50% of the height of the primary ribs. The side panels may alternatively be flat. The side panels may assist in sealing an edge of the separator to another edge of the separator as done when enveloping the separator, which is discussed hereinbelow.

In select exemplary embodiments, at least a portion of the negative ribs may preferably have a height of approximately 5% to approximately 100% of the height of the positive ribs. In some exemplary embodiments, the negative rib height may be approximately 5%, 10%, 15%, 20%, 25%, 30%, 35%, 40%, 45%, 50%, 55%, 60%, 65%, 70%, 75%, 80%, 95%, or 100% compared to the positive rib height. In other exemplary embodiments, the negative rib height may no greater than approximately 100%, 95%, 90%, 85%, 80%, 75%, 70%, 65%, 60%, 55%, 50%, 45%, 40%, 35%, 30%, 25%, 20%, 15%, 10%, or 5% compared to the positive rib height.

### Backweb Thickness

In some embodiments, the porous separator membrane can have a backweb thickness from approximately 50 μm to approximately 1.0 mm. for example, the backweb thickness may be may be approximately 50 μm, 100 μm, 200 μm, 300 μm, 400 μm, 500 μm, 600 μm, 700 μm, 800 μm, 900 μm, or 1.0 mm. In other exemplary embodiments, the backweb thickness T_{BACK} may be no greater than approximately 1.0 mm, 900 μm, 800 μm, 700 μm, 600 μm, 500 μm, 400 μm, 300 μm, 200 μm, 100 μm, or 50 μm. Though in certain embodiments, a very thin flat backweb thickness of 50 μm or thinner is provided, for example, between approximately 10 μm to approximately 50 μm thick.

The total thickness of exemplary separators (backweb thickness and the heights of positive and negative ribs) typically range from approximately 250 μm to approximately 4.0 mm. The total thickness of separators used in automotive start/stop batteries are typically approximately 250 μm to approximately 1.0 mm. The total thickness of separators used in industrial traction-type start/stop batteries are typically approximately 1.0 mm to approximately 4.0 mm.

### Form/Envelope

The separator 300 may be provided as a flat sheet, a leaf or leaves, a wrap, an s-wrap, a sleeve, or as an envelope or pocket separator. An exemplary envelope separator may envelope a positive electrode (“positive enveloping separator”), such that the separator has two interior sides facing the positive electrode and two exterior sides facing adjacent negative electrodes. Alternatively, another exemplary envelope separator may envelope a negative electrode (“negative enveloping separator”), such that the separator has two interior sides facing the negative electrode and two exterior sides facing adjacent positive electrodes. In such enveloped separators, the bottom edge may be a folded or a sealed crease edge. Further, the lateral edges may be continuously or intermittently sealed seam edges. The edges may be bonded or sealed by adhesive, heat, ultrasonic welding, and/or the like, or any combination thereof.

Certain exemplary separators may be processed to form hybrid envelopes. The hybrid envelope may be provided by forming one or more slits or openings before, during or after, folding the separator sheet in half and bonding edges of the separator sheet together so as to form an envelope. The length of the openings may be at least 1/50th, 1/25th, 1/20th, 1/15th, 1/10th, ⅛th, ⅕th, ¼th, or ⅓rd the length of the entire edge. The length of the openings may be 1/50th to ⅓rd, 1/25th to ⅓rd, 1/20th to ⅓rd, 1/20th to ¼th, 1/15th to ¼th, 1/15th to ⅕th or 1/10th to ⅕th the length of the entire edge. The hybrid envelope can have 1-5, 1-4, 2-4, 2-3 or 2 openings, which may or may not be equally disposed along the length of the bottom edge. It is preferred that no opening is in the corner of the envelope. The slits may be cut after the separator has been folded and sealed to give an envelope, or the slits may be formed prior to shaping the porous membrane into the envelope.

Some other exemplary embodiments of the separator 300 configurations include: a negative or positive electrode envelope; a negative or positive electrode sleeve, a negative or positive electrode hybrid envelope; both electrodes may be enveloped or sleeved, and any combination thereof.

### Electrical Resistance

In certain selected embodiments, the disclosed separators exhibit decreased electrical resistance (“ER”), for instance, an electrical resistance no greater than about 200 mΩ·cm², 180 mΩ·cm², 160 mΩ·cm², 140 mΩ·cm², 120 mΩ·cm², 100 mΩ·cm², 80 mΩ·cm², 60 mΩ·cm², 50 mΩ·cm², 40 mΩ·cm², 30 mΩ·cm², or 20 mΩ·cm². In various embodiments, the separators described herein exhibit about a 20% or more reduction in ER compared with a known separator of the same thickness. For example, a known separator may have an ER value of 60 mΩ·cm²; thus, a separator according to the present invention at the same thickness would have an ER value of less than about 48 mΩ·cm².

To test a sample separator for ER testing evaluation in accordance with the present invention, it must first be prepared. To do so, a sample separator is preferably submerged in a bath of demineralized water, the water is then brought to a boil and the separator is then removed after 10 minutes in the boiling demineralized water bath. After removal, excess water is shaken off the separator and then placed in a bath of sulfuric acid having a specific gravity of 1.280 at 27° C.±1° C. The separator is soaked in the sulfuric acid bath for 20 minutes. The separator is then ready to be tested for electrical resistance.

### Manufacture

In select embodiments, an exemplary separator may be made by mixing the constituent parts (e.g., base material and/or cross-linked material, filler, processing oil, and/or surfactant) in an extruder. In at least one preferred embodiment, a separator's constituent parts may include, for example, about 1-50% by weight cross-linkable component (e.g., rubber and/or latex) and/or about 5-15% by weight polymer (e.g., polyethylene), about 10-75% by weight filler (e.g., silica), and about 10-85% processing plasticizer (e.g., mineral oil). The separator may be made by passing the constituent parts through a heated extruder, passing the extrudate generated by the extruder through a die, and into a nip formed by two heated presses or calender stack or rolls to form a continuous web. A substantial amount of the processing plasticizer from the web may be extracted by use of a solvent, thereby followed with removing the solvent by drying (e.g., application of heat with or without forced convection). The web may then be coated with one or more performance-enhancing additives (e.g., surfactant(s) and/or battery water loss retardant(s)).

The additives may be applied via methods described elsewhere herein. The web may then be cut into lanes of predetermined width, and then wound onto rolls. Additionally, the presses or calender rolls may be engraved with various groove patterns to impart ribs, grooves, textured areas, embossments, and/or the like as substantially described herein. The amounts of the constituent parts are all balanced for runnability and desirable separator properties, such as electrical resistance, basis weight, puncture resistance, bending stiffness, oxidation resistance, porosity, physical strength, tortuosity, and the like.

In addition to and/or as an alternative to being added to the constituent parts of the extruder, certain embodiments combine the cross-linkable component to the porous membrane after extrusion. For example, the cross-linkable component may be coated onto one or both sides of the separator, preferably on the side facing the negative electrode, with a liquid slurry comprising the cross-linkable component (e.g., rubber and/or latex, and optionally silica and/or water), and then dried and/or at least partially cross-linked such that a film of this material is formed upon the surface of an exemplary porous membrane. In certain embodiments, the slurry can also contain one or more performance-enhancing additives (e.g., surfactants and/or battery water loss retardants) may be added to the slurry for use in lead acid batteries. After drying, a porous layer and/or film forms on the surface of the separator, which adheres very well to the porous membrane and increases electrical resistance only insignificantly, if at all. After the cross-linkable component is added, the separator may be further compressed using either a machine press or calender stack or roll. Other possible methods to apply the rubber and/or latex are to apply a rubber and/or latex slurry by dip coat, roller coat, spray coat, or curtain coat one or more surfaces of the separator, or any combination thereof. These processes may occur before or after the processing oil has been extracted, or before or after it is slit into lanes. A further embodiment of the present invention involves depositing rubber onto the membrane by impregnation and drying.

In addition, a cross-linkable component, which may or may not be at least partially cross-linked, may be at least partially cross-linked at any point in the process that makes practical sense. For instance, some rubber may be at least partially cross-linked prior to or after extrusion, after forming in a nip roller and/or calender roller processing, before or after the extraction of the processing plasticizer, after application of a cross-linkable component slurry, and/or before or after being cut into lanes, and any combination thereof. Furthermore, the cross-linkable component may be at least partially cross-linked during the manufacturing of the battery, including before or after assembly of the battery, and perhaps even during the forming of the battery.

The performance-enhancing additive may be added during the mixing of the constituent parts. In select embodiments, the performance-enhancing additive may also be applied to the separator as a coating, the application of which may be applied by dipping the separator in the additive or a solution of the additive (e.g., solvent bath addition) and removing the solvent if necessary (e.g., by drying with or without heat and/or forced convection). In this way the application of the additive may be combined, for example, with the extraction often applied during membrane production. Other preferred methods are to spray the surface with the additive or a solution of the additive, dip coating, roller coating, or curtain coating the one or more additives on the surface of separator. In other embodiments, the separator may be impregnated within the separator.

In certain embodiments, the performance-enhancing additive may be present as a surface coating at a density or add-on level of at least approximately 0.5 g/m² to approximately 25.0 g/m². In certain preferred embodiments, the additive may be present on the separator at a density of between 2.0 g/m² to approximately 10.0 g/m².

In certain embodiments described herein, a reduced amount of surfactant is added to the inventive separator. In such instances, a desirable feature may include lowered total organic carbons and/or lowered volatile organic compounds (because of the lower amount of surfactant) may produce a desirable inventive separator according to such embodiment.

In certain embodiments, and in addition or alternative to adding into the extruder, the additive or additives may, for example, be applied to the separator porous membrane when it is finished (e.g., after extracting a bulk of the processing oil, and before or after the introduction of the rubber). According to certain preferred embodiments, the additive or a solution (e.g., an aqueous solution) of the additive is applied to one or more surfaces of the separator. This variant is suitable in particular for the application of non-thermostable additives and additives that are soluble in the solvent used for the extraction of processing oil. Particularly suitable as solvents for the additives according to the invention are low-molecular-weight alcohols, such as methanol and ethanol, as well as mixtures of these alcohols with water. The application can take place on the side facing the negative electrode, the side facing the positive electrode, or on both sides of the separator. The application may also take place during the extraction of the pore forming agent (e.g., the processing oil) while in a solvent bath. In certain select embodiments, some portion of a performance-enhancing additive, such as a surfactant coating or a performance-enhancing additive added to the extruder before the separator is made (or both), may combine with the antimony in the battery system and may inactivate it, and/or form a compound with it, and/or cause it to drop down into the mud rest of the battery, and/or prevent it from depositing onto the negative electrode. The surfactant or additive may also be added to the electrolyte, the fibrous mat, the battery case, pasting paper, pasting mat, and/or the like, and any combination thereof.

Combined with a Fibrous Mat

In certain embodiments and as described herein, exemplary separators according to the present disclosure may be combined with a fibrous mat or layer (laminated or otherwise), such as fibrous may having enhanced wicking properties and/or enhanced wetting or holding of electrolyte properties. The fibrous mat may be nonwoven, fleeces, mesh, net, single layered, multi-layered (where each layer may have the same, similar or different characteristics than the other layers), composed of glass fibers, or synthetic fibers, fleeces or fabrics made from synthetic fibers or mixtures with glass and synthetic fibers or paper, or any combination thereof.

In certain embodiments, the fibrous mat (laminated or otherwise) may be used as a carrier for additional materials. The additional material may include, for example: a cross-linkable component that may or may not be at least partially cross-linked; silica; water; one or more performance-enhancing additive, such as various additives described herein (e.g., surfactants and/or water loss retardants); or any combination thereof. By way of example only, the additional material may be delivered in the form of a slurry that may then be coated onto one or more surfaces of the fibrous mat to form a film, or soaked and impregnated into the fibrous mat.

When the fibrous layer is present, it is preferred that the separator has a larger surface area than the fibrous layers. Thus, when combining the porous membrane and the fibrous layers, the fibrous layers do not completely cover the porous layer. It is preferred that at least two opposing edge regions of the membrane layer remain uncovered to provide edges for sealing which facilitates the optional formation of pockets, envelopes, sleeves, wraps, and/or the like. Such a fibrous mat may have a thickness that is at least 100 μm, in some embodiments, at least about 200 μm, at least about 250 μm, at least about 300 μm, at least about 400 μm, at least about 500 μm, at least about 600 μm, at least about 700 μm, at least about 800 μm, at least about 900 μm, at least about 1 mm, at least about 2 mm, and so forth. The subsequent laminated separator may be cut into pieces. In certain embodiments, the fibrous mat is laminated to a ribbed surface of the separator. In certain embodiments, handling and/or assembly advantages are provided to the battery maker with the improved separator described herein, as it may be supplied in roll form and/or cut piece form. And as mentioned previously, the improved separator may be a standalone separator sheet or layer without the addition of one or more fibrous mats and/or the like.

If the fibrous mat is laminated to the porous membrane, they may be bonded together by adhesive, heat, ultrasonic welding, compression, and/or the like, or any combination thereof. And, the fibrous mat may be a PAM or NAM retention mat, a pasting paper, and/or the like.

### EXAMPLES

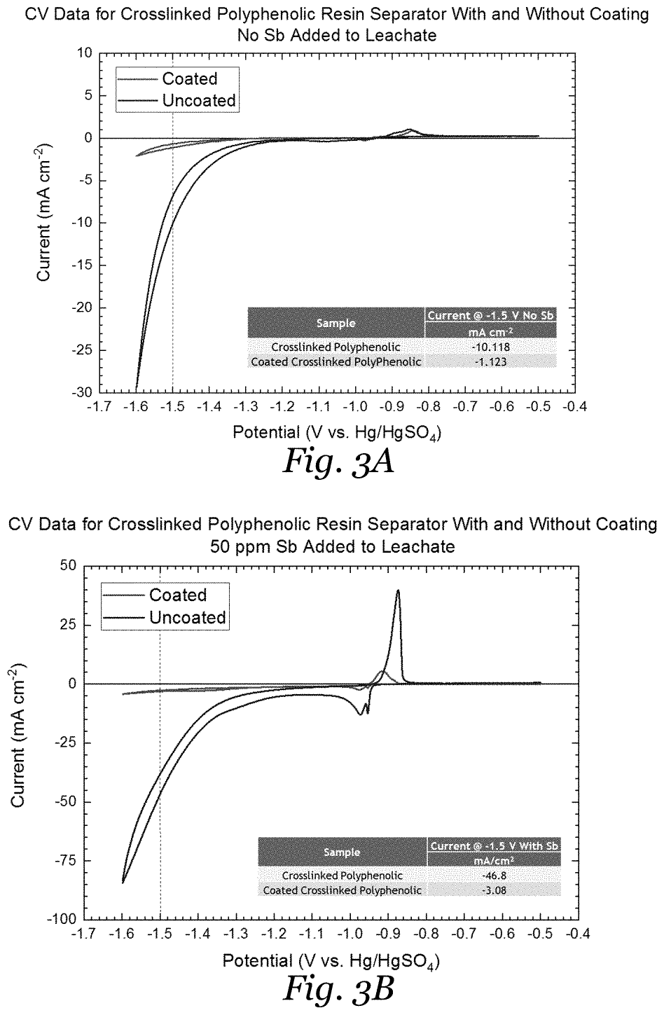

With reference now to FIGS. 3A and 3B, cyclic voltammetry data for a test cell having a cross-linked polyphenolic resin separator with and without a surfactant coating and with and without antimony (Sb) additions to the leachate. As shown in both figures, the separators with a surfactant coating consistently have a lower absolute value of cathodic current. When analyzed at −1.5 Volts relative to a reference electrode, the cathodic current absolute value of the coated separators are substantially, and surprisingly, lower than that of the uncoated separators. Furthermore, this is consistently seen with or without antimony added to the leachate. This indicates a lower hydrogen evolution, which indicates a lower water loss through the life of a battery utilizing the coated separator.

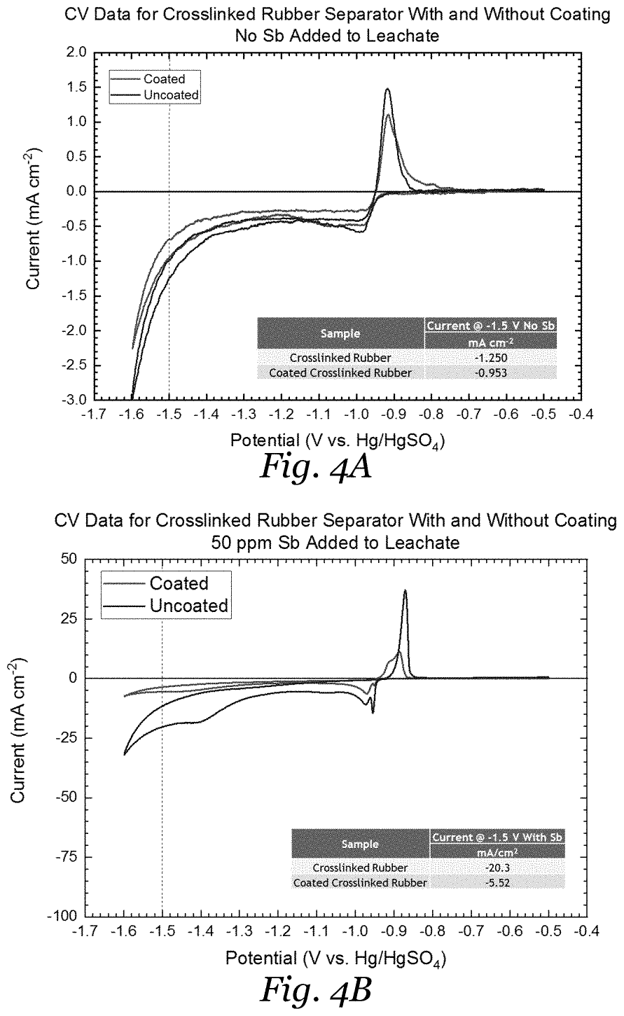

With reference now to FIGS. 4A and 4B, cyclic voltammetry data for a test cell having a separator having at least a portion of a rubber that is at least partially cross-linked with and without a surfactant coating and with and without antimony (Sb) additions to the leachate. As shown in both figures, the separators with a surfactant coating consistently have a lower absolute value of cathodic current. When analyzed at −1.5 Volts relative to a reference electrode, the cathodic current absolute value of the coated separators are substantially, and surprisingly, lower than that of the uncoated separators. Furthermore, this is consistently seen with or without antimony added to the leachate. This indicates a lower hydrogen evolution, which indicates a lower water loss through the life of a battery utilizing the coated separator.

### Conclusion

In accordance with at least select embodiments, the present disclosure or invention is directed to novel or improved separators, battery cells, batteries, systems, vehicles, and/or methods of manufacture and/or use of such novel separators, battery cells, and/or batteries. In accordance with at least certain embodiments, the present disclosure or invention is directed to novel or improved battery separators for the following batteries and/or applications, such as: flat-plate batteries, tubular batteries, flooded lead acid batteries, enhanced flooded lead acid batteries (“EFBs”), deep-cycle batteries, gel batteries, absorptive glass mat (“AGM”) batteries, valve regulated lead acid (“VRLA”) batteries, deep cycling batteries and/or batteries operating in a partial state of charge (“PSoC”), uninterruptible power supply (“UPS”) batteries, inverter batteries, renewable energy storage batteries, solar or wind power storage batteries, vehicle batteries, starting-lighting-ignition (“SLI”) vehicle batteries, idling-start-stop (“ISS”) vehicle batteries, hybrid-electric vehicle (“HEV”) batteries, hybrid vehicles, electric vehicles, batteries with high cold-cranking amp (“CCA”) requirements, batteries for internal combustion engines, marine battery applications, automobile batteries, truck batteries, motorcycle batteries, all-terrain vehicle batteries, forklift batteries, golf cart batteries, hybrid-electric vehicle batteries, electric vehicle batteries, e-rickshaw batteries, e-bike batteries, and/or the like, and/or improved methods of making and/or using such improved separators, cells, batteries, systems, and/or the like. In addition, disclosed herein are methods, systems and battery separators for enhancing battery performance and life, reducing battery failure, reducing water loss, mitigating antimony (Sb) poisoning, reducing acid stratification, mitigating dendrite formation, improving oxidation stability, improving, maintaining, and/or lowering float current, improving end of charge current, decreasing the current and/or voltage needed to charge and/or fully charge a deep cycle battery, reducing internal electrical resistance, improving acid diffusion, improving uniformity in a lead acid battery, and/or improving cycle performance. In accordance with at least particular embodiments, the present disclosure or invention is directed to an improved separator wherein the novel separator includes improved wettability, decreased water loss in a battery, decreased antimony (Sb) poisoning in a battery, decreased electrical resistance, performance-enhancing additives or coatings, improved fillers, optimized porosity, increased wettability, increased acid diffusion, negative cross ribs, and/or the like.

In accordance with at least selected embodiments, the present disclosure or invention is directed to separators, particularly separators for flooded lead acid batteries, capable of reducing or mitigating battery water loss, reducing antimony (Sb) poisoning, mitigating electrode plate grid warping or bowing or cupping; reducing or mitigating acid starvation; reducing or mitigating acid stratification; reducing or mitigating dendrite growth; reducing the effects of oxidation; reducing water loss; increasing wettability; improving acid diffusion; improving uniformity; and having reduced electrical resistance, capable of increasing cold cranking amps, and/or the like; and combinations thereof. In addition, disclosed herein are methods, systems, and battery separators for enhancing battery life; reducing battery water loss; reducing battery antimony (Sb) poisoning; reducing or mitigating electrode plate grid warping or bowing or cupping; reducing or mitigating acid starvation; reducing or mitigating acid stratification; reducing or mitigating dendrite growth; reducing the effects of oxidation; reducing internal resistance; increasing wettability; improving acid diffusion; improving cold cranking amps; improving uniformity; and/or the like; and any combination thereof in at least enhanced flooded lead acid batteries. In accordance with at least particular embodiments, the present disclosure or invention is directed to an improved separator for enhanced flooded lead acid batteries wherein the separator includes an improved formulation for reduced battery water loss and reduced antimony (Sb) poisoning, an improved separator grid-warp resistance, improved separator resiliency; and combinations thereof. In accordance with at least particular embodiments, the present disclosure or invention is directed to improved separators for enhanced flooded lead acid batteries wherein the separator includes an improved formulation including cross-linked components, performance-enhancing additives or coatings, increased oxidation resistance, amorphous silica, higher oil absorption silica, higher silanol group silica, silica with an OH:Si ratio of 21:100 to 35:100, a polyolefin microporous membrane containing particle-like filler in an amount of 40% or more by weight of the membrane and polymer, such as ultrahigh molecular weight polyethylene (“UHMWPE”), decreased sheet thickness, reduced thickness, reduced oil content, increased wettability, increased acid diffusion, and/or the like, and any combination thereof.

In a first select embodiment of the present disclosure or invention, a battery separator may be provided with a porous membrane and a performance-enhancing surfactant, agent, or additive (e.g., a coating of a surfactant and/or a water loss surfactant). In certain select embodiments, one or both of the porous membrane or performance-enhancing additive may have a cross-linkable component, which may be at least partially cross-linked. An alternative embodiment of a separator of the present invention may be provided with a polyolefin, an additional cross-linkable component, and a surfactant, agent, or additive; the additional cross-linkable component may be at least partially cross-linked. In other embodiments, the separator may be provided with a fibrous mat that may or may not have a cross-linkable component that may be at least partially cross-linked.

In certain aspects, the cross-linkable component may be at least partially cross-linked via thermal cross-linking; radiative cross-linking; chemical cross-linking; physical cross-linking; pressure cross-linking; and/or oxidative cross-linking; and any combination thereof. In addition, the cross-linkable component may be at least partially cross-linked via exposure to electron beam radiation; gamma radiation; ultra-violet light; vulcanization; and/or hydrogen peroxide (H2O2); and any combination thereof. Further, the cross-linkable component may be at least partially cross-linked at least one of: a covalent bond; an ionic bond; and a combination thereof.

In another aspect of the present invention, exemplary cross-linkable component may be at least one of the following: a natural rubber; latex; a synthetic rubber; a polymer; a phenolic resin; polyacrylamide resin; polyvinyl chloride (PVC); and/or bisphenol formaldehyde; and any combination thereof. Further, the separator may also have as a constituent material: a polymer; a polyolefin; polyethylene; polypropylene; ultra-high molecular weight polyethylene (“UHMWPE”); a lignin; a wood pulp; a synthetic wood pulp (“SWP”); glass fibers; synthetic fibers; and/or cellulosic fibers; and any combination thereof.

Exemplary battery separators may further have a particle-like filler. Exemplary fillers may include: amorphous silica; higher oil absorption silica; higher silanol group silica; silica with an OH to Si ratio of 21:100 to 35:100; and a combination thereof.

Exemplary performance-enhancing additives may include a surfactant and/or a water loss (as measured in a lead acid battery) retardant. Exemplary additives may be incorporated within said porous membrane and/or a coating on at least a portion of one and/or both surfaces of the separator.

Exemplary surfactants, agents, or additives may have a hydrophilic lipophilic balance (HLB) at least greater than or equal to approximately one (1), and/or at most less than equal to approximately three (3). Exemplary surfactants, agents, or additives may be one of an ionic surfactant; a non-ionic surfactant; and a combination thereof. Exemplary surfactants may further contain one or more of: a ethoxylated alcohol; a propoxylated alcohol; block copolymers of ethylene oxide; block copolymers of propylene oxide; polymerizable units; epoxies; urethanes; and any combination thereof. Exemplary surfactants, agents, or additives may a surface weight on the separator of at least approximately 2.0 g/m², and/or no greater than approximately 10.0 g/m².

Exemplary separators of the present invention may have a first plurality of ribs that may be disposed on a first side of the separator. Exemplary embodiments of the first plurality of ribs may be a uniform set, an alternating set, or a mix or combination of at least one of: solid ribs, discrete broken ribs, continuous ribs, discontinuous ribs, discontinuous peaks, discontinuous protrusions, angled ribs, diagonal ribs, linear ribs, ribs that are longitudinally extending substantially in a machine direction of said porous membrane, ribs that are laterally extending substantially in a cross-machine direction of said porous membrane, ribs that are transversely extending substantially in said cross-machine direction of the separator, transversely extending negative mini ribs, negative cross ribs (NCR), acid mixing ribs, discrete teeth, toothed ribs, serrations, serrated ribs, battlements, battlemented ribs, curved ribs, continuous sinusoidal ribs, discontinuous sinusoidal ribs, S-shaped ribs, continuous zig-zag-sawtooth-like ribs, broken discontinuous zig-zag-sawtooth-like ribs, grooves, channels, textured areas, embossments, dimples, columns, mini columns, porous, non-porous, cross ribs, mini ribs, cross-mini ribs, and combinations thereof.

At least a portion of the first plurality of ribs may be defined by a first angle that is neither parallel nor orthogonal relative to an edge of the separator. Further, at least a portion of the first plurality of ribs may be defined by a first angle defined as relative to a machine direction of the separator that may be between greater than zero degrees (0°) and less than 180 degrees (180°), and greater than 180 degrees (180°) and less than 360 degrees (360°).

In addition, exemplary separators may have a second plurality of ribs, which may be disposed on a second side of the separator. Further, the second plurality of ribs may be a uniform set, an alternating set, or a mix or combination of at least one of the following group consisting of: solid ribs, discrete broken ribs, continuous ribs, discontinuous ribs, discontinuous peaks, discontinuous protrusions, angled ribs, diagonal ribs, linear ribs, ribs that are longitudinally extending substantially in a machine direction of said porous membrane, ribs that are laterally extending substantially in a cross-machine direction of said porous membrane, ribs that are transversely extending substantially in said cross-machine direction of the separator, transversely extending negative mini ribs, negative cross ribs (NCR), acid mixing ribs, discrete teeth, toothed ribs, serrations, serrated ribs, battlements, battlemented ribs, curved ribs, continuous sinusoidal ribs, discontinuous sinusoidal ribs, S-shaped ribs, continuous zig-zag-sawtooth-like ribs, broken discontinuous zig-zag-sawtooth-like ribs, grooves, channels, textured areas, embossments, dimples, columns, mini columns, porous, non-porous, cross ribs, mini ribs, cross-mini ribs, and combinations thereof.

In select embodiments, at least a portion of the second plurality of ribs may be defined by a second angle that is neither parallel nor orthogonal relative to an edge of the separator. Further, at least a portion of the second plurality of ribs may be defined by a second angle defined as relative to a machine direction of the porous membrane that may be between greater than zero degrees (0°) and less than 180 degrees (180°), and greater than 180 degrees (180°) and less than 360 degrees (360°).

Another aspect of the present invention may provide the separator as an envelope separator, a sleeve separator, a hybrid envelope separator, a pocket separator, a wrap separator, a cut-piece separator, a leaf separator, and/or an s-wrap separator.

In yet another aspect, the separator may be coupled with a fibrous mat, which may be nonwoven; mesh; fleece; net; and any combination thereof, and may further be layers of those elements. Exemplary fibrous mats may include one or more of glass fibers; synthetic fibers; silica; a cross-linkable component at least partially cross-linked; a surfactant, agent, or additive; a water loss retardant; latex; natural rubber; synthetic rubber; a polymer; phenolic resin; polyacrylamide; polyvinyl chloride (PVC); bisphenol formaldehyde; and any combination thereof.

In select embodiments, a battery separator may be provided with a porous membrane, a fibrous mat, a cross-linkable component at least partially cross-linked, and a surfactant, agent, or additive. Exemplary cross-linkable components may be at least partially provided within the fibrous mat. Further, exemplary surfactants, agents, or additives may be at least partially provided within the fibrous mat. In addition, exemplary cross-linkable components and/or exemplary surfactants, agents, or additives may be at least partially provided in or on the porous membrane.

In certain select embodiments, a lead acid battery is provided with at least one positive electrode, at least one negative electrode, a sulfuric acid (H₂SO₄) electrolyte; and an inventive battery separator as described herein. The positive electrode(s) may be provided with antimony (Sb) or as an antimony alloy. The exemplary separator may suppress antimony poisoning in the battery. In addition, the exemplary separator may suppress hydrogen (H₂) evolution and/or suppress electrolytic water loss in the battery.

Exemplary lead acid batteries may be one of: a flat-plate battery; a flooded lead acid battery; an enhanced flooded lead acid battery (“EFB”); a valve regulated lead acid (“VRLA”) battery; a deep-cycle battery; a gel battery; an absorptive glass mat (“AGM”) battery; a tubular battery; an inverter battery; a battery for an internal combustion engine; a vehicle battery; an auxiliary battery; a starting-lighting-ignition (“SLI”) vehicle battery; an idling-start-stop (“ISS”) vehicle battery; an automobile battery; a truck battery; a motorcycle battery; an all-terrain vehicle battery; a marine battery; an aircraft battery, a forklift battery; a golf cart battery; a hybrid-electric vehicle battery; an electric vehicle battery; an e-rickshaw battery; an e-trike battery; an e-bike battery; an uninterruptible power supply battery; a battery with high cold-cranking amps (“CCA”); and a combination thereof.

Exemplary lead acid batteries may operate in a partial state of charge (“PSoC”).

In certain select embodiments, a system having an inventive lead acid battery as described herein may be provided. The exemplary system may be one of: a vehicle; an uninterruptible power supply; an auxiliary power system; a renewable energy power collector; a wind energy power collector; a solar energy power collector; a backup power system; an inverter; and a combination thereof. Further, exemplary vehicles may be one of: an automobile; a passenger vehicle; a truck; a forklift; a hybrid vehicle; a hybrid-electric vehicle; a micro-hybrid vehicle; an idling-start-stop (“ISS”) vehicle; an electric vehicle; an e-bike, an e-rickshaw; an e-trike; a motorcycle; a water vessel; an aircraft, an all-terrain vehicle; a golf car; and a combination thereof.

In accordance with at least select embodiments, aspects or objects, the present disclosure or invention is directed to or may provide novel or improved separators, particularly separators for lead acid batteries; novel or improved separators, battery separators, batteries, cells, systems, vehicles, and/or methods of manufacture and/or use of such separators, battery separators, cells, systems, and/or batteries; an improved separator for lead acid batteries and/or improved methods of using such batteries having such improved separators; methods, systems, treatments, and battery separators for enhancing battery life, reducing battery failure, reducing battery water loss, reducing battery antimony poisoning, lowering battery float current, minimizing battery internal resistance increases, increasing separator wettability, reducing battery acid stratification, improving battery acid diffusion, and/or improving uniformity in lead acid batteries; an improved separator for lead acid batteries wherein the separator includes improved functional coatings, improved formulations, improved battery separators which reduce water loss in lead acid batteries, improved battery separators which reduce antimony poisoning in lead acid batteries, improved lead acid batteries including such improved separators, long life lead acid batteries, improved flooded lead acid batteries, improved enhanced flooded lead acid batteries, improved deep cycle batteries and/or batteries operating in a partial state of charge, and/or the like, and/or batteries having reduced antimony poisoning, reduced floating charges and/or reduced electrolysis and/or reduced rates of water loss; a polymer separator comprising a cross-linkable component and a surfactant; a separator comprising a cross-linkable component and an surfactant; a polymer separator comprising a cross-linkable component and a surfactant additive; a separator comprising a cross-linkable component and a surfactant additive; a polymer separator comprising a cross-linkable component and a surfactant coating; a separator comprising a cross-linkable component and a surfactant coating; a polymer separator comprising a cross-linkable component and a battery water loss reducing additive; a separator comprising a cross-linkable component and a battery water loss reducing additive; a polymer separator comprising a cross-linkable component at least partially cross-linked, and a surfactant; a separator comprising a cross-linkable component at least partially cross-linked and an surfactant; a polymer separator comprising a cross-linkable component at least partially cross-linked and a surfactant additive; a separator comprising a cross-linkable component at least partially cross-linked and a surfactant additive; a polymer separator comprising a cross-linkable component at least partially cross-linked and a surfactant coating; a separator comprising a cross-linkable component at least partially cross-linked and a surfactant coating; a polymer separator comprising a cross-linkable component at least partially cross-linked and a battery water loss reducing additive; a separator comprising a cross-linkable component at least partially cross-linked and a battery water loss reducing additive, and/or the like as shown or described herein; a battery separator and/or the like as shown or described herein.

In accordance with at least select embodiments, the present disclosure or invention is directed to novel or improved separators for lead acid batteries, such as flooded lead acid batteries, and in particular enhanced flooded lead acid batteries (“EFBs”), and various other lead acid batteries, such as gel and absorptive glass mat (“AGM”) batteries, deep cycle batteries, golf car batteries, and/or the like. In accordance with at least select embodiments, the present disclosure or invention is directed to novel or improved separators, battery separators, low water loss separators, oxidation resistant separators, negative cross rib (NCR) separators, grid warp resistant separators, resilient separators, acid mixing separators, balanced separators, EFB separators, separators that improve battery performance, separators that dramatically improve battery performance, batteries, improved batteries, dramatically improved batteries, cells, systems, methods involving the same, vehicles using the same, methods of manufacturing the same, the use of the same, and/or combinations thereof. In addition, disclosed herein are methods, systems, and battery separators for enhancing battery life and reducing battery failure by reducing battery electrode shorting, reducing water loss, reducing electrical resistance, improving cycle life, and/or the like.

In accordance with at least select embodiments, the present disclosure or invention is directed to novel or improved separators, battery cells, batteries, systems, vehicles, and/or methods of manufacture and/or use of such novel separators, battery cells, and/or batteries. In accordance with at least certain embodiments, the present disclosure or invention is directed to novel or improved battery separators for the following batteries and/or applications, such as: flat-plate batteries, tubular batteries, flooded lead acid batteries, enhanced flooded lead acid batteries (“EFBs”), deep-cycle batteries, gel batteries, absorptive glass mat (“AGM”) batteries, valve regulated lead acid (“VRLA”) batteries, deep cycling batteries and/or batteries operating in a partial state of charge (“PSoC”), uninterruptible power supply (“UPS”) batteries, inverter batteries, renewable energy storage batteries, solar or wind power storage batteries, vehicle batteries, starting-lighting-ignition (“SLI”) vehicle batteries, idling-start-stop (“ISS”) vehicle batteries, hybrid-electric vehicle (“HEV”) batteries, hybrid vehicles, electric vehicles, batteries with high cold-cranking amp (“CCA”) requirements, batteries for internal combustion engines, marine battery applications, automobile batteries, truck batteries, motorcycle batteries, all-terrain vehicle batteries, forklift batteries, golf cart batteries, hybrid-electric vehicle batteries, electric vehicle batteries, e-rickshaw batteries, e-bike batteries, and/or the like, and/or improved methods of making and/or using such improved separators, cells, batteries, systems, and/or the like. In addition, disclosed herein are methods, systems and battery separators for enhancing battery performance and life, reducing battery failure, reducing water loss, mitigating antimony (Sb) poisoning, reducing acid stratification, mitigating dendrite formation, improving oxidation stability, improving, maintaining, and/or lowering float current, improving end of charge current, decreasing the current and/or voltage needed to charge and/or fully charge a deep cycle battery, reducing internal electrical resistance, improving energy throughput, improving acid diffusion, improving uniformity in a lead acid battery, and/or improving cycle life or cycle performance. In accordance with at least particular embodiments, the present disclosure or invention is directed to an improved separator wherein the novel separator includes improved wettability, decreased water loss in a battery, decreased antimony (Sb) poisoning in a battery, decreased electrical resistance, performance-enhancing additives or coatings, improved fillers, optimized porosity, increased wettability, increased acid diffusion, negative cross ribs, and/or the like.

In accordance with at least selected embodiments, the present disclosure or invention is directed to separators, particularly separators for flooded lead acid batteries, capable of reducing or mitigating battery water loss, reducing antimony (Sb) poisoning, mitigating electrode plate grid warping or bowing or cupping; reducing or mitigating acid starvation; reducing or mitigating acid stratification; reducing or mitigating dendrite growth; reducing the effects of oxidation; reducing water loss; increasing wettability; improving acid diffusion; improving uniformity; and having reduced electrical resistance, capable of increasing cold cranking amps, and/or the like; and combinations thereof. In addition, disclosed herein are methods, systems, and battery separators for enhancing battery life; reducing battery water loss; reducing battery antimony (Sb) poisoning; reducing or mitigating electrode plate grid warping or bowing or cupping; reducing or mitigating acid starvation; reducing or mitigating acid stratification; reducing or mitigating dendrite growth; reducing the effects of oxidation; reducing internal resistance; increasing wettability; improving acid diffusion; improving cold cranking amps; improving uniformity; and/or the like; and any combination thereof in at least enhanced flooded lead acid batteries. In accordance with at least particular embodiments, the present disclosure or invention is directed to an improved separator for enhanced flooded lead acid batteries wherein the separator includes an improved formulation for reduced battery water loss and reduced antimony (Sb) poisoning, an improved separator grid-warp resistance, improved separator resiliency; and combinations thereof. In accordance with at least particular embodiments, the present disclosure or invention is directed to improved separators for enhanced flooded lead acid batteries wherein the separator includes an improved formulation including cross-linked components, performance-enhancing additives or coatings, increased oxidation resistance, amorphous silica, higher oil absorption silica, higher silanol group silica, silica with an OH:Si ratio of 21:100 to 35:100, a polyolefin microporous membrane containing particle-like filler in an amount of 40% or more by weight of the membrane and polymer, such as ultrahigh molecular weight polyethylene (“UHMWPE”), decreased sheet thickness, reduced thickness, reduced oil content, increased wettability, increased acid diffusion, and/or the like, and any combination thereof.

In accordance with at least selected embodiments, objects or aspects of the present invention, provided or disclosed herein are exemplary embodiments of novel or improved membranes, microporous membranes, separators for batteries, particularly lead acid batteries, and more particularly enhanced flooded lead acid batteries, improved lead acid batteries incorporating the improved separators, systems incorporating the improved separators and/or batteries, and/or methods related thereto that may address the problems, issues, or shortcomings of prior membranes, separators, batteries, systems, and/or the like. The novel or improved separators may contain a cross-linkable component and a surfactant, agent, or additive. Furthermore, the cross-linkable component may be at least partially cross-linked. In addition, the separator may further be composed of a polymer and a filler, and may be additionally paired with at least one fibrous mat or scrim, may be a piece, sleeve, pocket, envelope, wrap, fold, or the like, and/or combinations thereof.

The foregoing written description of structures and methods has been presented for purposes of illustration only. Examples are used to disclose exemplary embodiments, including the best mode, and also to enable any person skilled in the art to practice the invention, including making and using any devices or systems and performing any incorporated methods. These examples are not intended to be exhaustive or to limit the invention to the precise steps and/or forms disclosed, and many modifications and variations are possible in light of the above teaching. Features described herein may be combined in any combination. Steps of a method described herein may be performed in any sequence that is physically possible. The patentable scope of the invention is defined by the appended claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The present invention may be embodied in other forms without departing from the spirit and the essential attributes thereof, and, accordingly, reference should be made to the appended claims, rather than to the foregoing specification, as indicating the scope of the invention. Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

The compositions and methods of the appended claims are not limited in scope by the specific compositions and methods described herein, which are intended as illustrations of a few aspects of the claims. Any composition(s) and/or method(s) that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches. Unless defined otherwise, all technical and scientific terms used herein have the same meanings as commonly understood by one of skill in the art to which the disclosed invention belongs. Publications cited herein and the materials for which they are cited are specifically incorporated by reference.

As used in the specification and the appended claims, the singular forms “a,” “an,” and “the” include plural referents unless the context clearly dictates otherwise. Ranges may be expressed herein as from “about” or “approximately” one particular value, and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers, or steps. The terms “consisting essentially of” and “consisting of” may be used in place of “comprising” and “including” to provide for more specific embodiments of the invention and are also disclosed. “Exemplary” or “for example” means “an example of” and is not intended to convey an indication of a preferred or ideal embodiment. Similarly, “such as” is not used in a restrictive sense, but for explanatory or exemplary purposes.

Additionally, the invention illustratively disclosed herein may be suitably practiced in the absence of any element that is not specifically disclosed herein.

1. A battery separator comprising:
a porous membrane comprising a surfactant, agent, and/or additive; and
wherein one or more of said porous membrane and said surfactant, agent, and/or additive comprise a cross-linkable component.

2. The battery separator of claim 1, wherein said cross-linkable component:
is at least on a surface of said porous membrane;
is at least partially cross-linked via at least one of the following group consisting of: thermal cross-linking; radiative cross-linking; chemical cross-linking; physical cross-linking; pressure cross-linking; oxidative cross-linking; and a combination thereof;
is at least partially cross-linked via exposure to at least one of the following group consisting of: electron beam radiation; gamma radiation; ultra-violet light; vulcanization; hydrogen peroxide (H₂O₂); and a combination thereof;
is at least partially cross-linked as at least one of the following group consisting of: a covalent bond; an ionic bond; and a combination thereof; or
comprises at least one of the following group consisting of: a natural rubber; latex; a synthetic rubber; a polymer; a phenolic resin; polyacrylamide resin; polyvinyl chloride (PVC); bisphenol formaldehyde; cross-linkable monomers; and a combination thereof.

3. (canceled)

4. (canceled)

5. (canceled)

6. (canceled)

7. The battery separator of claim 1, wherein said porous membrane;
further comprises at least one of the following group consisting of: a polymer; a polyolefin; polyethylene; polypropylene; ultra-high molecular weight polyethylene (“UHMWPE”); a lignin; a wood pulp; a synthetic wood pulp (“SWP”); glass fibers; synthetic fibers; cellulosic fibers; and a combination thereof;
further comprises a particle-like filler; or
further comprises a particle-like filler, wherein said particle-like filler is one or more of the following group consisting of: amorphous silica; higher oil absorption silica; friable silica; higher silanol group silica; silica with an OH to Si ratio of 21:100 to 35:100; and a combination thereof.

8. (canceled)

9. (canceled)

10. The battery separator of claim 1, wherein said surfactant, agent, or additive:
is a water loss retardant;
is incorporated within said porous membrane; or
is a coating on at least a portion of a surface of said porous membrane.

11. (canceled)

12. (canceled)

13. The battery separator of claim 1, wherein said surfactant, agent, or additive has a hydrophilic lipophilic balance (HLB) at least greater than or equal to approximately 1 or at most less than or equal to approximately 3.

14. (canceled)

15. The battery separator of claim 1, wherein said surfactant, agent, or additive: comprises at least one of the following group consisting of: an ionic surfactant; a non-ionic surfactant; and a combination thereof; or
comprises at least one of the following group consisting of: a ethoxylated alcohol; a propoxylated alcohol; block copolymers of ethylene oxide; block copolymers of propylene oxide; polymerizable units; epoxies; urethanes; and a combination thereof.

16. (canceled)

17. The battery separator of any of claim 1, wherein said surfactant, agent, or additive is a coating on at least a portion of a surface of said porous membrane at a surface weight of at least approximately 2.0 g/m², or of no greater than approximately 10.0 g/m².

18. (canceled)

19. The battery separator of claim 1, wherein said porous membrane comprises a plurality of ribs, wherein:
said plurality of ribs are at least partially disposed on a first side of said porous membrane;
said plurality of ribs are at least one of the following group consisting of: solid ribs, discrete broken ribs, continuous ribs, discontinuous ribs, discontinuous peaks, discontinuous protrusions, angled ribs, diagonal ribs, linear ribs, ribs that are longitudinally extending substantially in a machine direction of said porous membrane, ribs that are laterally extending substantially in a cross-machine direction of said porous membrane, ribs that are transversely extending substantially in said cross-machine direction of the separator, transversely extending negative mini ribs, negative cross ribs (NCR), acid mixing ribs, discrete teeth, toothed ribs, serrations, serrated ribs, battlements, battlemented ribs, curved ribs, continuous sinusoidal ribs, discontinuous sinusoidal ribs, S-shaped ribs, continuous zig-zag-sawtooth-like ribs, broken discontinuous zig-zag-sawtooth-like ribs, grooves, channels, textured areas, embossments, dimples, columns, mini columns, porous, non-porous, cross ribs, mini ribs, cross-mini ribs, and combinations thereof; or
at least a portion of said plurality of ribs is defined by a first angle that is neither parallel nor orthogonal relative to an edge of said porous membrane.

20. (canceled)

21. (canceled)

22. (canceled)

23. The battery separator of claim 1 is one of the group consisting of an envelope separator, a sleeve separator, a hybrid envelope separator, a pocket separator, a wrap separator, a cut-piece separator, a leaf separator, and an s-wrap separator.

24. The battery separator of claim 1, further comprising a fibrous mat, wherein:
said fibrous mat is one of the following group consisting of: nonwoven; mesh; fleece; net; and a combination thereof; or
said fibrous mat comprises one of the following group consisting of glass fibers; synthetic fibers; silica; a cross-linkable component at least partially cross-linked; a surfactant, agent, or additive; a water loss retardant; latex; natural rubber; synthetic rubber; a polymer; phenolic resin; polyacrylamide; polyvinyl chloride (PVC); bisphenol formaldehyde; and a combination thereof.

25. (canceled)

26. (canceled)

27. A battery separator comprising:
a porous membrane;
a fibrous mat; and
a surfactant, agent, or additive; and
wherein one or more of said porous membrane, said fibrous mat, and said surfactant, agent, or additive comprise a cross-linkable component.

28. The battery separator of claim 27, wherein:
said cross-linkable component is at least partially cross-linked;
said cross-linkable component is at least partially cross-linked via at least one of the following group consisting of: thermal cross-linking; radiative cross-linking; chemical cross-linking; physical cross-linking; pressure cross-linking; oxidative cross-linking; and a combination thereof;
said cross-linkable component is at least partially cross-linked via exposure to at least one of the following group consisting of: electron beam radiation; gamma radiation; ultra-violet light; vulcanization; hydrogen peroxide (H₂O₂); and a combination thereof;
said cross-linkable component is at least partially cross-linked as at least one of the following group consisting of: a covalent bond; an ionic bond; and a combination thereof; or
said cross-linkable component comprises at least one of the following group consisting of: a natural rubber; latex; a synthetic rubber; a polymer; a phenolic resin; polyacrylamide resin; polyvinyl chloride (PVC); bisphenol formaldehyde; and a combination thereof.

29. (canceled)

30. (canceled)

31. (canceled)

32. (canceled)

33. The battery separator of claim 27, wherein said polyolefin is one of the following group consisting of: polypropylene; high molecular weight polypropylene; ultra-high molecular weight polypropylene; polyethylene; high molecular weight polyethylene; ultra-high molecular weight polyethylene; and a combination thereof.

34. The battery separator of claim 27, wherein said porous membrane further comprises at least one of the following group consisting of: a lignin; a wood pulp; a synthetic wood pulp (“SWP”); glass fibers; synthetic fibers; cellulosic fibers; and a combination thereof.

35. The battery separator of claim 27, wherein said porous membrane:
further comprises a particle-like filler; or
further comprises a particle-like filler, wherein said particle-like filler is optionally one or more of the following group consisting of: amorphous silica; higher oil absorption silica; higher silanol group silica; silica with an OH to Si ratio of 21:100 to 35:100; and a combination thereof.

36. (canceled)

37. The battery separator of claim 27, wherein said surfactant, agent, or additive:
is a water loss retardant;
is incorporated within the porous membrane;
is a coating on at least a portion of a surface of said porous membrane;
has a hydrophilic lipophilic balance (HLB) at least greater than or equal to approximately 1;
has a hydrophilic lipophilic balance (HLB) at most less than or equal to approximately 3;
comprises at least one of the following group consisting of: an ionic surfactant; a non-ionic surfactant; and a combination thereof;
comprises at least one of the following group consisting of: an ethoxylated alcohol; a propoxylated alcohol; a block copolymer of ethylene oxide; a block copolymer of propylene oxide; polymerizable units; epoxies; urethanes; and a combination thereof;
is a coating on at least a portion of a surface of said porous membrane at a surface weight of at least approximately 2.0 g/m²; or
is a coating on at least a portion of a surface of said porous membrane at a surface weight of no greater than approximately 10.0 g/m².

38. (canceled)

39. (canceled)

40. (canceled)

41. (canceled)

42. (canceled)

43. (canceled)

44. (canceled)

45. (canceled)

46. The battery separator of claim 27, wherein:
said porous membrane comprises a plurality of ribs;
said porous membrane comprises a plurality of ribs, wherein said plurality of ribs are at least one of the following group consisting of: solid ribs, discrete broken ribs, continuous ribs, discontinuous ribs, discontinuous peaks, discontinuous protrusions, angled ribs, diagonal ribs, linear ribs, ribs that are longitudinally extending substantially in a machine direction of said porous membrane, ribs that are laterally extending substantially in a cross-machine direction of said porous membrane, ribs that are transversely extending substantially in said cross-machine direction of the separator, transversely extending negative mini ribs, negative cross ribs (NCR), acid mixing ribs, discrete teeth, toothed ribs, serrations, serrated ribs, battlements, battlemented ribs, curved ribs, continuous sinusoidal ribs, discontinuous sinusoidal ribs, S-shaped ribs, continuous zig-zag-sawtooth-like ribs, broken discontinuous zig-zag-sawtooth-like ribs, grooves, channels, textured areas, embossments, dimples, columns, mini columns, porous, non-porous, cross ribs, mini ribs, cross-mini ribs, and combinations thereof; or
said porous membrane comprises a plurality of ribs, wherein at least a portion of said plurality of ribs is defined by a first angle that is neither parallel nor orthogonal relative to an edge of said porous membrane.

47. (canceled)

48. (canceled)

49. The battery separator of claim 27 is one of the group consisting of an envelope separator, a positive envelope, a negative envelope, a sleeve separator, a hybrid envelope separator, a pocket separator, a wrap separator, a cut-piece separator, a leaf separator, and an s-wrap separator.

50. The battery separator of claim 27, wherein said fibrous mat comprises one of the following group consisting of glass fibers; synthetic fibers; silica; a cross-linkable component at least partially cross-linked; a surfactant, agent, or additive; a water loss retardant; latex; natural rubber; synthetic rubber; a polymer; phenolic resin; polyacrylamide; polyvinyl chloride (PVC); bisphenol formaldehyde; and a combination thereof.

51. (canceled)

52. A lead acid battery comprising the battery separator of claim 1, wherein:
said at least one positive electrode comprises antimony (Sb);
said at least one positive electrode comprises antimony (Sb) and said separator suppresses antimony (Sb) poisoning;
said separator suppresses electrolyte hydrogen (H₂) evolution;
said separator suppresses electrolytic water loss in said battery;
said lead acid battery being at least one of the following group consisting of: a flat-plate battery; a flooded lead acid battery; an enhanced flooded lead acid battery (“EFB”); a valve regulated lead acid (“VRLA”) battery; a deep-cycle battery; a gel battery; an absorptive glass mat (“AGM”) battery; a tubular battery; an inverter battery; a battery for an internal combustion engine; a vehicle battery; an auxiliary battery; a starting-lighting-ignition (“SLI”) vehicle battery; an idling-start-stop (“ISS”) vehicle battery; an automobile battery; a truck battery; a motorcycle battery; an all-terrain vehicle battery; a marine battery; an aircraft battery, a forklift battery; a golf cart battery; a hybrid-electric vehicle battery; an electric vehicle battery; an e-rickshaw battery; an e-trike battery; an e-bike battery; an uninterruptible power supply battery; a battery with high cold-cranking amps (“CCA”); and a combination thereof; or
said lead acid battery operates in a partial state of charge (“PSoC”).

53. (canceled)

54. (canceled)

55. (canceled)

56. (canceled)

57. (canceled)

58. (canceled)

59. A system comprising the lead acid battery of claim 52:
further comprising at least one of the following group consisting of: a vehicle; an uninterruptible power supply; an auxiliary power system; a renewable energy power collector; a wind energy power collector; a solar energy power collector; a backup power system; an inverter; and a combination thereof; or
further comprising at least one of the following group consisting of: a vehicle; an uninterruptible power supply; an auxiliary power system; a renewable energy power collector; a wind energy power collector; a solar energy power collector; a backup power system; an inverter; and a combination thereof, wherein said vehicle is one of the following group consisting of: an automobile; a passenger vehicle; a truck; a forklift; a hybrid vehicle; a hybrid-electric vehicle; a micro-hybrid vehicle; an idling-start-stop (“ISS”) vehicle; an electric vehicle; an e-bike, an e-rickshaw; an e-trike; a motorcycle; a water vessel; an aircraft, an all-terrain vehicle; a golf car; and a combination thereof.

60. (canceled)

61. (canceled)

62. (canceled)

63. A lead acid battery separator comprising:
a porous polymer membrane comprising at least one of a surfactant, agent, or additive; and
wherein one or more of said porous membrane or said at least one of a surfactant, agent, or additive comprise a cross-linkable component.

64. (canceled)

65. The battery separator of claim 63, wherein:
said membrane is a polyolefin membrane and said cross-linkable component is at least on a surface of said porous membrane;
said cross-linkable component is at least partially cross-linked via at least one of the following group consisting of: thermal cross-linking; radiative cross-linking;
chemical cross-linking; physical cross-linking; pressure cross-linking; oxidative cross-linking; and a combination thereof;
said cross-linkable component is at least partially cross-linked via exposure to at least one of the following group consisting of: electron beam radiation; gamma radiation; ultra-violet light; vulcanization; hydrogen peroxide (H₂O₂); and a combination thereof;
said cross-linkable component is at least partially cross-linked as at least one of the following group consisting of: a covalent bond; an ionic bond; and a combination thereof; or
said cross-linkable component comprises at least one of the following group consisting of: a natural rubber; latex; a synthetic rubber; a polymer; a phenolic resin; polyacrylamide resin; polyvinyl chloride (PVC); bisphenol formaldehyde; cross-linkable monomers; and a combination thereof.

66. (canceled)

67. (canceled)

68. (canceled)

69. The battery separator of claim 63, wherein said porous membrane further comprises at least one of the following group consisting of: a polymer; a polyolefin; polyethylene; polypropylene; ultra-high molecular weight polyethylene (“UHMWPE”); a lignin; a wood pulp; a synthetic wood pulp (“SWP”); glass fibers; synthetic fibers; cellulosic fibers; and a combination thereof.

70. The battery separator of claim 63, wherein said surfactant, agent, or additive:
is a water loss retardant;
has a hydrophilic lipophilic balance (HLB) at least greater than or equal to approximately 1;
has a hydrophilic lipophilic balance (HLB) at most less than or equal to approximately 3;
comprises at least one of the following group consisting of: an ionic surfactant; a non-ionic surfactant; and a combination thereof;
comprises at least one of the following group consisting of: a ethoxylated alcohol;
a propoxylated alcohol; block copolymers of ethylene oxide; block copolymers of propylene oxide; polymerizable units; epoxies; urethanes; and a combination thereof;
is a coating on at least a portion of a surface of said porous membrane at a surface weight of at least approximately 2.0 g/m²; or
is a coating on at least a portion of a surface of said porous membrane at a surface weight of no greater than approximately 10.0 g/m².

71. (canceled)

72. (canceled)

73. (canceled)

74. (canceled)

75. (canceled)

76. (canceled)

77. The battery separator of claim 63, wherein:
said porous membrane comprises a plurality of ribs; or said porous membrane comprises a plurality of ribs, and said plurality of ribs are at least one of the following group consisting of: solid ribs, discrete broken ribs, continuous ribs, discontinuous ribs, discontinuous peaks, discontinuous protrusions, angled ribs, diagonal ribs, linear ribs, ribs that are longitudinally extending substantially in a machine direction of said porous membrane, ribs that are laterally extending substantially in a cross-machine direction of said porous membrane, ribs that are transversely extending substantially in said cross-machine direction of the separator, transversely extending negative mini ribs, negative cross ribs (NCR), acid mixing ribs, discrete teeth, toothed ribs, serrations, serrated ribs, battlements, battlemented ribs, curved ribs, continuous sinusoidal ribs, discontinuous sinusoidal ribs, S-shaped ribs, continuous zig-zag-sawtooth-like ribs, broken discontinuous zig-zag-sawtooth-like ribs, grooves, channels, textured areas, embossments, dimples, columns, mini columns, porous, non-porous, cross ribs, mini ribs, cross-mini ribs, and combinations thereof.

78. (canceled)

79. The battery separator of claim 63, further comprising a fibrous mat.

80. A lead acid battery separator comprising:
a porous polyethylene and silica membrane;
a fibrous mat; and
a surfactant, agent, and/or additive; and
wherein one or more of said porous membrane, said fibrous mat, and said surfactant, agent, or additive comprise a cross-linkable component.

81. (canceled)

82. (canceled)

83. (canceled)

84. (canceled)

85. An improved AGM battery separator comprising:
An AGM having a surfactant, agent, and/or additive; and
wherein one or more of said AGM and said surfactant, agent, and/or additive comprise a cross-linkable component.
